(19) United States
(12) Patent Application Publication
(10) Pub. No.: US 2024/0005701 A1
(43) Pub. Date: Jan. 4, 2024

(54) METHODS AND APPARATUS FOR TEAM CLASSIFICATION IN SPORTS ANALYSIS

(71) Applicant: Intel Corporation, Santa Clara, CA (US)

(72) Inventors: Chenning Liu, Beijing (CN); Qiang Li, Beijing (CN); Wenlong Li, Beijing (CN); Yikai Fang, Beijing (CN); Hang Zheng, Beijing (CN); Jiansheng Chen, Beijing (CN)

(21) Appl. No.: 18/254,818

(22) PCT Filed: Sep. 23, 2021
(86) PCT No.: PCT/CN2021/119876

§ 371 Date: May 26, 2023

(51) Int. Cl. G06V 40/20; G06V 10/82; G06V 10/764

(52) U.S. Cl. CPC G06V 40/23; G06V 10/764; G06V 10/82

(57) ABSTRACT

An example apparatus includes processor circuitry to extract features from image data obtained from a plurality of cameras, the extraction of features performed using a plurality of sequential neural network layers; in response to each of the plurality of sequential neural network layer extracting the features, identify the extracted features in a torso region of the image data via a plurality of attention modules; estimate body landmarks from image data to localize an area; generate an upper heatmap mask based on a geometric center of the image data; calculate a loss function for the image data based on a cross-entropy loss, a pixel-wise loss, and a triplet loss determined from the extracted features and the generated heatmap mask; select lowest correlated classes based on calculated correlations between pairs of a plurality of classes; and calculate voting scores for groups associated with the lowest correlated classes.

### FIELD OF THE DISCLOSURE

This disclosure relates generally to machine-based data processing and, more particularly, for team classification in sports analysis.

### BACKGROUND

Sports are played on many levels ranging from youth sports to national and international professional-level sports. In many levels of competition, player and team identifications are often collected to associate statistics with players/teams and memorialize past player and team performances. Many fans use team labels during a sports game to follow the players and teams progress during the game.

### BRIEF DESCRIPTION OF THE DRAWINGS

FIG. 1 is a schematic illustration of an example environment in which teachings of this disclosure may be implemented.

FIG. 2 illustrates an example system constructed in accordance with teachings of this disclosure and including example external device(s) and example team analysis circuitry for team classification in image data collected from cameras.

FIG. 3 is a block diagram of example team classification circuitry included in the example team analysis circuitry of FIG. 2.

FIG. 4 is a block diagram of example pose-guided iterative attention network circuitry included in the example team classification circuitry of FIG. 3.

FIG. 5 is a flow diagram of example self-attention module circuitry included in the example pose-guided iterative attention network circuitry of FIG. 4.

FIG. 6 illustrates a diagram of example inputs and output feature vectors of the example team classification circuitry of FIGS. 2 and/or 3.

FIG. 7 is a schematic of example graphs from comparisons of three example classes in accordance with teachings of this disclosure.

FIG. 8 is an example table of example correlation coefficients between pairs of classes in accordance with teachings of this disclosure.

FIG. 9 is a block diagram of example inputs and output classifications of the example team classification circuitry of FIGS. 2 and/or 3.

FIGS. 10A, 10B illustrate example graphics from the classification results of the example team classification circuitry of FIGS. 2 and/or 3.

FIG. 11 is a flowchart representative of example machine readable instructions that may be executed by example processor circuitry to implement the example team analysis circuitry of FIG. 2 and the example team classification circuitry of FIGS. 2 and/or 3.

FIG. 12 is a flowchart representative of example machine readable instructions that may be executed by example processor circuitry to implement the example pose-guided iterative attention network circuitry included in the example team classification circuitry of FIGS. 2, 3, and/or 4.

FIG. 13 is a flowchart representative of example machine readable instructions that may be executed by example processor circuitry to implement an example first neural network layer, an example second neural network layer, an example third neural network layer, an example fourth neural network layer, and example self-attention module circuitry included in the example pose-guided iterative attention network circuitry of FIGS. 4 and/or 5.

FIG. 14 is a flowchart representative of example machine readable instructions that may be executed by example processor circuitry to implement example class score calculation circuitry and example pairwise correlation calculation circuitry included in example multi-camera team feature fusion circuitry of FIG. 3.

FIG. 15 is a flowchart representative of example machine readable instructions that may be executed by example processor circuitry to implement example multi-camera voting score calculation circuitry included in the example multi-camera team feature fusion circuitry of FIG. 3.

FIG. 16 is a block diagram of an example processing platform including processor circuitry structured to execute the example machine readable instructions of FIGS. 11-15 to implement the example team classification circuitry 210 of FIGS. 2 and/or 3.

FIG. 17 is a block diagram of an example implementation of the processor circuitry of FIG. 16.

FIG. 18 is a block diagram of another example implementation of the processor circuitry of FIG. 16.

FIG. 19 is a block diagram of an example software distribution platform (e.g., one or more servers) to distribute software (e.g., software corresponding to the example machine readable instructions of FIGS. 11-15) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

In many levels of sports competition, player and team identifications are often collected to help viewers identify specific players and teams during a game, associate statistics with the players/teams, and memorialize past player and team performances. Many fans use team labels during a sports game to follow the players and teams progress during the game. In examples disclosed herein, the location of the sports competition (e.g., a stadium, an arena, etc.) include multiple cameras located around a perimeter of the location. Examples disclosed herein identify players and teams based on data from the cameras to allow for player tracking using team identity, jersey numbers, player location, etc. during the sports competition.

However, there are several challenges to assigning team labels to players in a sports competition/game, specifically when there is no prior knowledge available (e.g., the visual appears of each team). For example, there are dozens of teams from multiple clubs across each state, nation, etc. in the sports game. In some examples, each team usually has 3 to 4 sets of jerseys/uniforms for each season, and new jerseys may also be designed for a new season. Two teams in a game will only choose two jerseys with appearance discriminability. However, such information is usually not known before the game starts. Furthermore, dynamic weather, illumination changes, and player occlusions also make assigning team labels to players more difficult. These constraints make accurate team classification very challenging without any prior data or manual intervention.

In some examples, team classification can be obtained from training a logistic regression classifier that maps image patches to team labels (e.g., team A, team B, and other), where image patches are represented by RGB color histograms. However, the color histogram does not contain the spatial position information, so it is difficult to distinguish the two teams correctly when players have similar color histograms. In some examples, team classification can be obtained using a histogram-based matching approach to identify the team of a given player. However, such examples are dependent on a priori information (e.g., the style of the jersey template snapshots for each game), which need to be labelled manually before the sports game starts. Thus, such examples fail when the player image patch is different from the jersey template due to lighting change.

In some examples, team classification can be obtained using deep learning multi-class methods where each jersey style corresponds to a class label in the network design, and the top class is taken as the corresponding team label during prediction. However, if each team has more than one set of jerseys (e.g., 4 jerseys for each team in the national football league (NFL)), this method is error prone to collect all of the jerseys before the game starts and would lead to a labor intensive process. Additionally, if the uniforms across the teams are very similar, coupled with the change of the lighting/body posture, it is difficult to train a classifier in this method to accurately distinguish the player's team. Furthermore, the classified two teams in this method may be assigned to different classes, but to merge them into a correct set would also be challenging for this method.

Previous methods have included unsupervised approaches that rely on color features that are very sensitive to lighting conditions, which result in low accuracy. Additionally, previous solutions using jersey templates are non-automatic and require priori information that is also difficult to collect in most sports games. Furthermore, the deep learning methods with a multiple classes model have low classification accuracy and poor generalization performance because the model category number is very high due to the diversity of jerseys. In such examples, the models cannot distinguish jerseys with similar color/pattern, and the method tends to classify the detected jerseys into multiple classes. The previous methods also do not handle the occlusion between players and/or a solution to fuse the team classification results from multiple cameras.

Examples disclosed herein include enable team classification for sports competitions/games without requiring live game information or manual operation. Examples disclosed herein are also robust to jersey variation, illumination, occlusion etc. as well as occlusions among players. For example, when several players are close in position or huddled together, there is a high degree of occlusion. In such examples, the occluded player can only be seen partially in camera view. In other examples, although players wear the same uniform in one team, there are no restrictions on limbs, which allows some players to wear some personal accessories on their arms or legs (e.g., a bandana, an arm band, socks with random colors, etc.). In such examples, these variations in personal accessories can cause ambiguity for team classification. Examples disclosed herein include a multi-head iterative attention network structure (referred to as a pose-guided iterative attention network (PIANet) structure) that leverages the upper body heatmap to highlight relevant regions both at channel and spatial dimensions and iteratively extracts features from the low-level details of the image data to the high-level semantics. In examples disclosed herein, the PIANet uses a self-attention mechanism to iteratively highlight a player torso region from the low-level details in the image data to the high-level semantics. In examples disclosed herein, the PIANet uses the pose to estimate an upper torso heatmap to guide the feature focus on the upper body of the player, thereby eliminating the influence of player occlusion and background. In addition, the PIANet includes a composite loss function to increase distance between different classes and reduce the distance within the same class, thereby improving the model generalization ability. In examples disclosed herein, the composite loss function includes a pixelwise loss, a classification loss, and a triplet loss. In examples disclosed herein, the PIANet structure substantially improves the resistibility to the lighting change or occlusions in image data.

Example disclosed herein further include a multi-camera fusion module that automatically abstracts a multi-class model into a two-class domain for a specific game by calculating the correlation weights between the pre-designed classes. Directly using a multi-classification model without using a two-class transformer would incorrectly assign some players to the wrong category. To address the dimensionality gap of applying multi-category models to the binary classification in a sports game scenario, examples disclosed herein include the multi-camera fusion module to automatically select the two most significant classes by leveraging the correlation weights between the feature vectors of the pre-designed multi-class model. Therefore, examples disclosed herein are able to transform the multi-class classification problem into two classification domains.

Example disclosed herein further include a multi-dimension fusion module to produce a high-precision team label based on the two-class domain determined for the specific game. To address the impact of camera angle and player scale under a single camera (e.g., the appearance difference between two teams' players from side view is not significant), examples disclosed herein effectively fuse the output of each single view to achieve higher accuracy.

Example disclosed herein provide new ways of live broadcast and analysis. Real-time, stable, and high accuracy team classification plays a critical role in volumetric video generation, virtual camera selection, BTP (be the player), tactical analysis and all other relevant scenarios that relate to players identity. Examples disclosed herein can automatically and accurately classify the players into separate teams. Example disclosed herein do not require manual operation or live game data to train the models for the PIANet, the multi-camera fusion module, and the multi-dimension fusion module.

While examples disclosed herein are described particularly in the context of sport scenarios, such examples may additionally or alternatively be used in other scenarios and/or contexts as well. For example, images may be analyzed to determine the presence of a uniformed personnel and, perhaps, an organization which they represent. As an example, a city surveillance system might utilize the example techniques disclosed herein to determine whether a uniformed personnel is present at the scene of an accident. More particularly, such example techniques might be utilized to determine whether the uniformed personnel (e.g., a first responder) is a police officer, a firefighter, a paramedic, etc. Such information could then be used to better direct first responders and/or request additional assistance from various organizations.

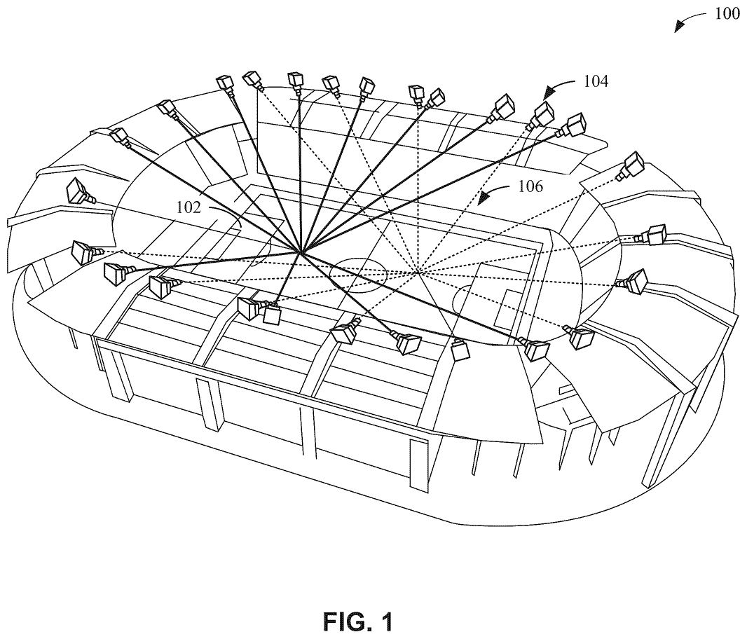

FIG. 1 is a schematic illustration of an example environment 100 in which teachings of this disclosure may be implemented. In the illustrated example of FIG. 1, the environment 100 is illustrated as a stadium. However, examples disclosed herein may be implemented in other environments such as, for example, an arena. The example environment 100 of FIG. 1 includes an example field 102, example camera(s) 104, and example views 106. In the illustrated example, the environment 100 includes the example camera(s) 104 set up around the circumference of the environment 100. The example camera(s) 104 are calibrated to record videos of the example field 102 during a sports event/game (e.g., a football game, a soccer game, a basketball game, etc.). In the illustrated example, the environment 100 includes 38 of the example camera(s) 104. However, the example environment 100 can include any number of the example camera(s) 104.

In the illustrated example of FIG. 1, the example camera(s) 104 capture high-resolution image data of the example field 102. The example camera(s) 104 enable creation of different views 106 of the example field 102. In the illustrated example, each of the views 106 associated with the camera(s) 104 are unique perspectives of the field 102. In the illustrated example, each of the views 106 include different visual information of the example field 102. In the illustrated example of FIG. 1, the example camera(s) 104 employ segmentation and 3D reconstruction of the example field 102 to create a 3D, volumetric model. In examples disclosed herein, a virtual camera is placed in the 3D space to navigate the 3D scene of the field 102 to follow a player or ball during a sports game. Examples disclosed herein use the image data from the example camera(s) 104 to determine player classifications and team classifications during a sports game.

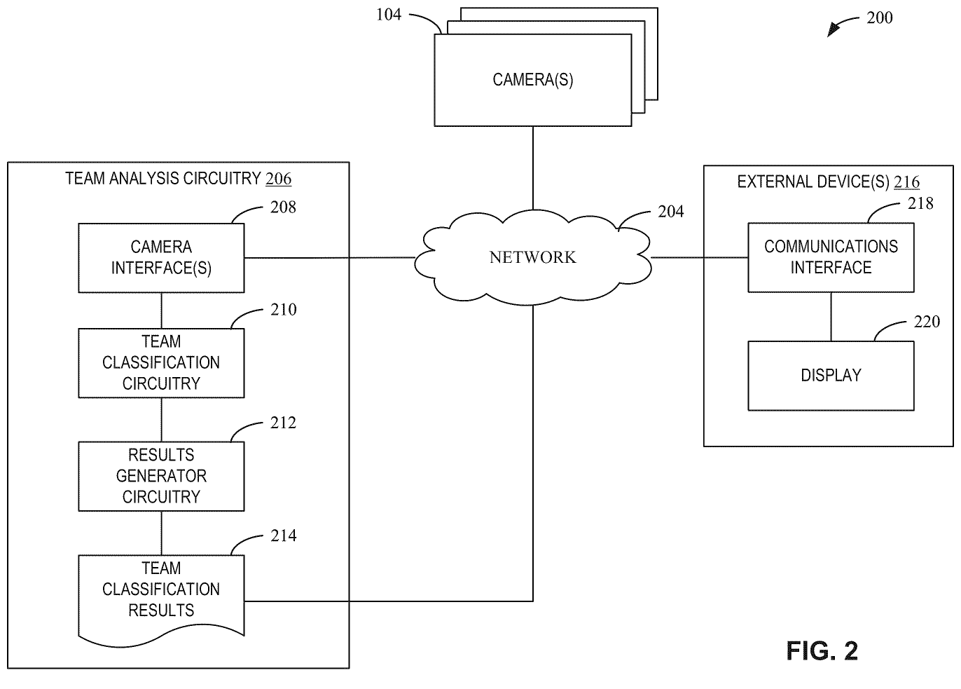

FIG. 2 illustrates an example system 200 constructed in accordance with teachings of this disclosure and including example external device(s) 216 and example team analysis circuitry 206 for team classification in image data collected from camera. The example system 200 includes the example camera(s) 104 of FIG. 1 and an example network 204, example team analysis circuitry 206, and example external devices 216. In the illustrated example, the team analysis circuitry 206 includes an example camera interface(s) 208, example team classification circuitry 210, example results generator circuitry 212, and example team classification results 214. In the illustrated example, the external device(s) 216 includes an example communications interface 218 and an example display 220.

The example network 204 is a network used to transmit the video/image data from the example camera(s) 104 to the team analysis circuitry 206. In the illustrated example, the network 204 transmits the image/video data from the example camera(s) 104 and the example team classification results 214 from the example team analysis circuitry 206 to the example external device(s) 216. In some examples, the network 204 can be the Internet or any other suitable external network. In other examples, any other suitable means of transmitting the video/image data from the example camera(s) 104 to the team analysis circuitry 206 and/or transmitting the image/video data from the example camera(s) 104 and the example team classification results 214 from the example team analysis circuitry 206 to the example external device(s) 216 can be used.

In the illustrated example of FIG. 2, the example team analysis circuitry 206 processes the video/image data from the example camera(s) 104. In the illustrated example, the team analysis circuitry 206 includes the example camera interface(s) 208 to obtain the video/image data from the example camera(s) 104. In some examples, there is only one camera included in the camera(s) 104 and only one camera interface included in the camera interface(s) 208 receives the image/video data collected by the example camera(s) 104 via the example network 204. In some examples, the camera interface(s) 208 collects the video/image data respectively from each of the example camera(s) 104. In some examples, the camera interface(s) 208 provides the example video/image data to the example team classification circuitry 210.

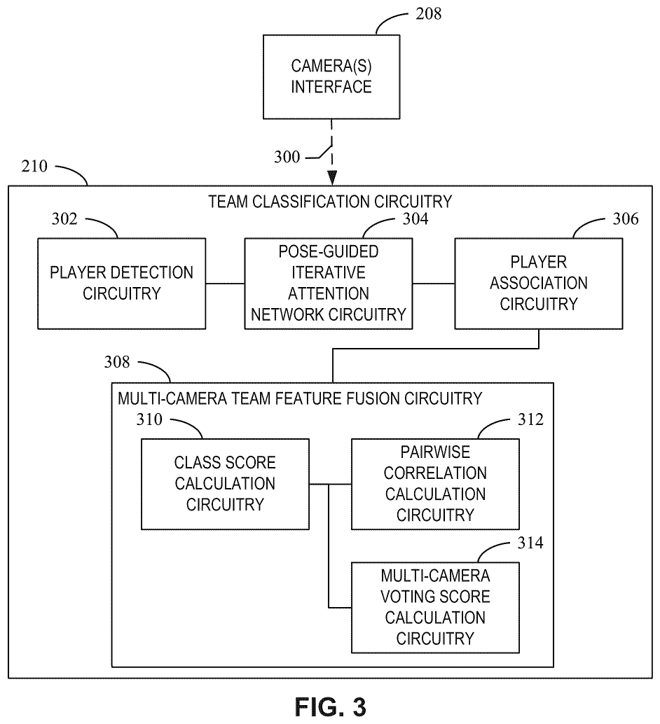

In the illustrated example, the example team analysis circuitry 206 includes the example team classification circuitry 210 to analyze the video/image data from the camera interface(s) 208 to identify players in a sport game and classify the identified players into separate teams. The example team classification circuitry 210 includes an iterative attention network structure that determines an upper body heatmap to highlight relevant regions of the image data and iteratively extracted features from the details of the image data. The example team classification circuitry 210 includes a multi-camera fusion module that generates a two-class domain model for a specific game in the image data by calculating the correlation weights between pre-designed classes. The example team classification circuitry 210 further includes a multi-dimension fusion module that determines team labels for the image data based on the two-class domain model determined for the game. An example implementation of the example team classification circuitry 210 is described below in conjunction with FIG. 3.

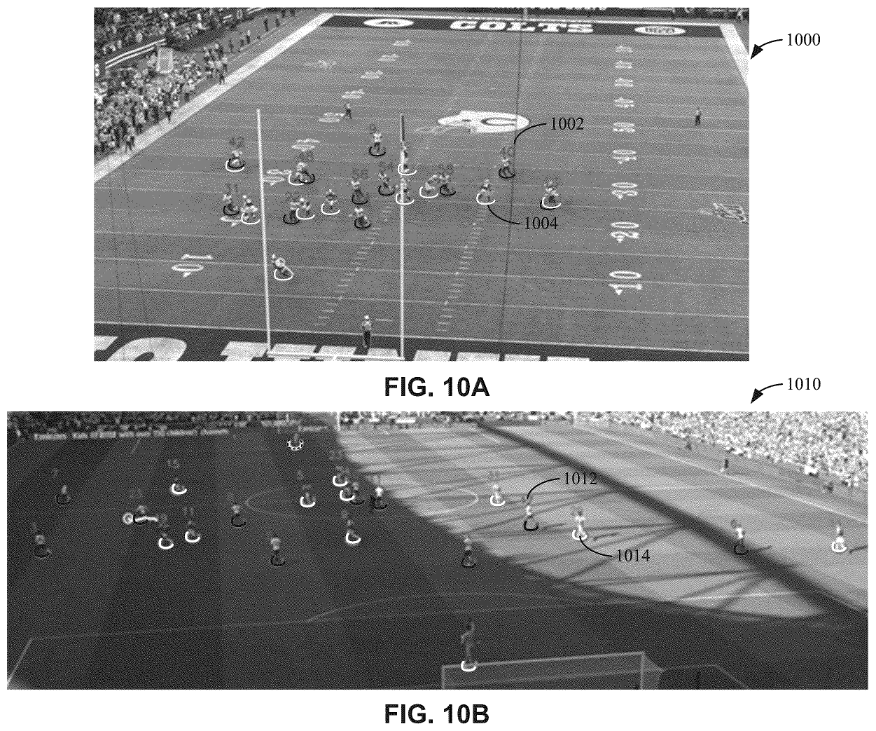

In the illustrated example of FIG. 2, the example team analysis circuitry 206 includes the example results generator circuitry 212 to output the results of the example team classification circuitry 210. In some examples, the results generator circuitry 212 obtains the team and player classifications determined by the example team classification circuitry 210. In some examples, the results generator circuitry 212 generates the example team classification results 214 from the team and player classifications. In some examples, the results generator circuitry 212 generates identifiers of the team and player classifications on the image data from the example camera(s) 104. Examples of the team classification results 214 from the example results generator circuitry 212 are illustrated below in connection with FIGS. 10A, 10B. In some examples, the results generator circuitry 212 outputs the example team classification results 214 to the example external devices 216 via the example network 204.

In the illustrated example, the example external devices 216 are other user devices and/or media devices that receive the video/image data from the example camera(s) 104 via the example network 204. In some examples, the external devices 216 can included a smartphone, television, streaming devices, etc. In the illustrated example of FIG. 2, the external devices 216 include the example communications interface 218 to receive the video/image data from the example camera(s) 104 and the example team classification results 214 from the example team analysis circuitry 206. In some examples, the example communications interface 218 combines the video/image data and the example team classification results 214. The example external devices 216 also include the example display 220 to output the combination of the video/image data and the example team classification results 214. Examples of outputs of the example display 220 are illustrated below in connection with FIGS. 10A, 10B.

FIG. 3 is a block diagram of example team classification circuitry 210 included in the example team analysis circuitry 206 of FIG. 2. The example team classification circuitry 210 of FIG. 3 includes example player detection circuitry 302, example pose-guided iterative attention network (PIANet) circuitry 304, example player association circuitry 306, and example multi-camera team feature fusion circuitry 308. In the illustrated example, the example multi-camera team feature fusion circuitry 308 includes example class score calculation circuitry 310, example pairwise correlation calculation circuitry 312, and example multi-camera voting score calculation circuitry 314.

In the illustrated example, the example player detection circuitry 302 identifies players in example image data 300 from the example camera interface(s) 208. The example player detection circuitry 302 removes any non-sport field area from the example image data 300 using a pre-defined court mask. As used herein, a non-sport field includes areas in the example image data 300 that are from the venue (e.g., an auditorium, a stadium, an arena, etc.) and/or from other people and support staff (e.g., coaching staff, venue staff, etc.). In the illustrated example, the player detection circuitry 302 detects all players in a play field of the example image data 300. In some examples, the player detection circuitry 302 detects the players using a person detection algorithm such as, for example, You Only Look Once (YOLO), Single Short MultiBox Detector (SSD), Fast Region Based Convolutional Neural Networks (Fast-RCNN), etc. The example player detection circuitry 302 determines bounding boxes for the detected players. In some examples, the example player detection circuitry 302 labels the bounding boxes with identifiers (e.g., numbers, letters, etc.) that identify each player bounding box. The example player detection circuitry 302 transmits the detected player information in the example image data 300 to the example PIANet circuitry 304.

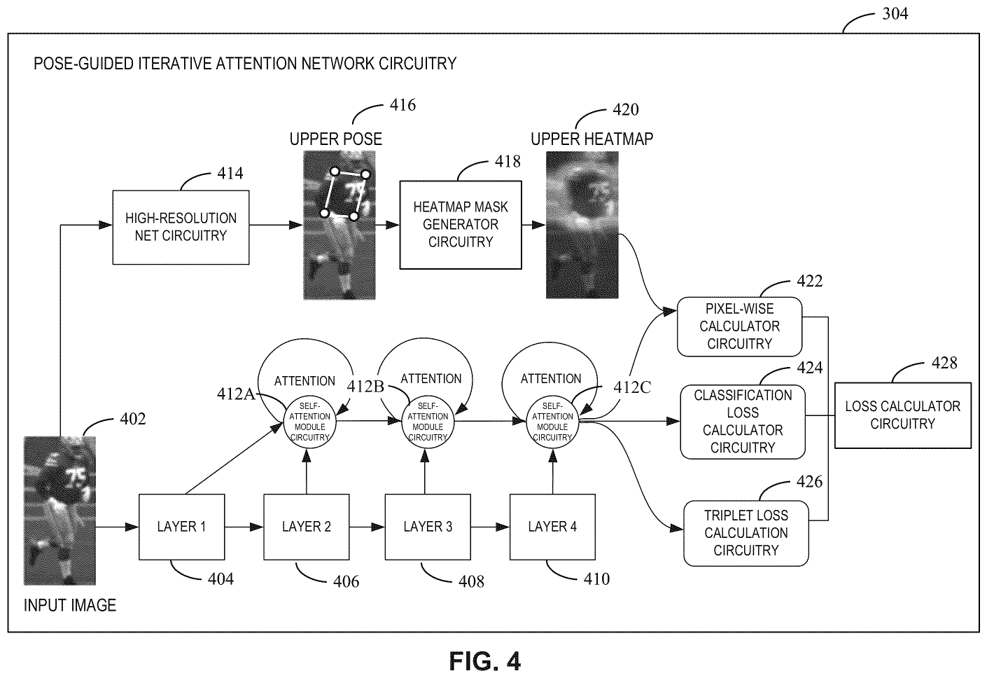

The example PIANet circuitry 304 extracts features from the example image data 300 for the detected players identified by the example player detection circuitry 302. In the illustrated example, the PIANet circuitry 304 extracts features from the example image data 300 using sequential neural network layers. The example PIANet circuitry 304 identifies the extracted features in an upper torso region of the detected player using self-attention modules in parallel with each of the sequential neural network layers. The example PIANet circuitry 304 determines an upper heatmap mask in parallel to the sequential neural network layers based on the example image data 300 to localize the features on the relevant region of an upper torso of the player. The example PIANet circuitry 304 calculates a loss function for the example image data 300 based on different losses determined from the focused extracted features and generated heatmap mask. The example PIANet circuitry 304 compares the extracted features from the image data 300 to different predetermined classes (e.g., team classifications). In examples disclosed herein, the different classes represent different team jersey characteristics. For example, in the NFL, there may be 64 sets of team jerseys across the league. In examples disclosed herein, jerseys with similar colors and styles may be merged into the same classes to enhance the discrimination between classes and improve generalization ability of the PIANet circuitry 304. The example PIANet circuitry 304 uses the different classes to determine scores of the similarities between the classes and the extracted features from the image data 300. An example implementation of the example PIANet circuitry 304 is illustrated below in connection with FIG. 4.

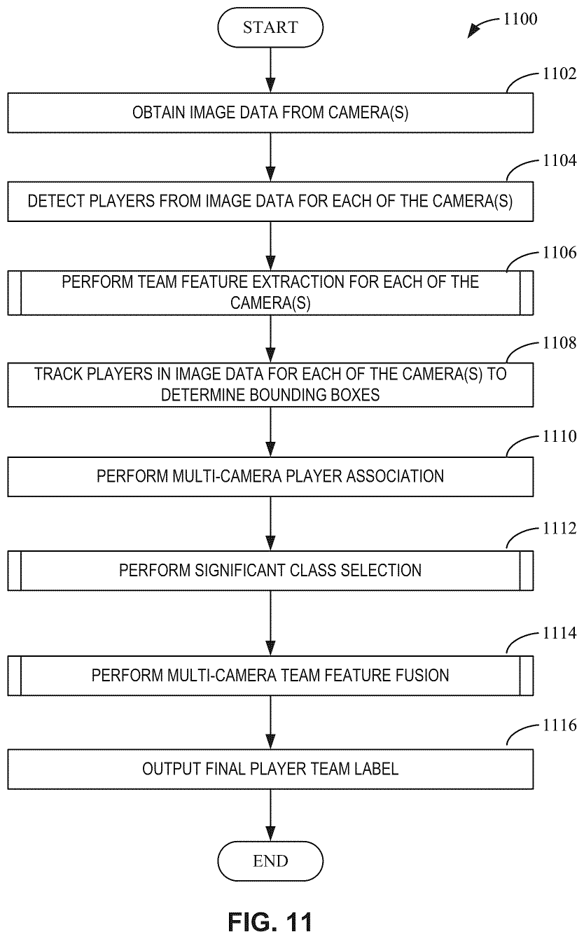

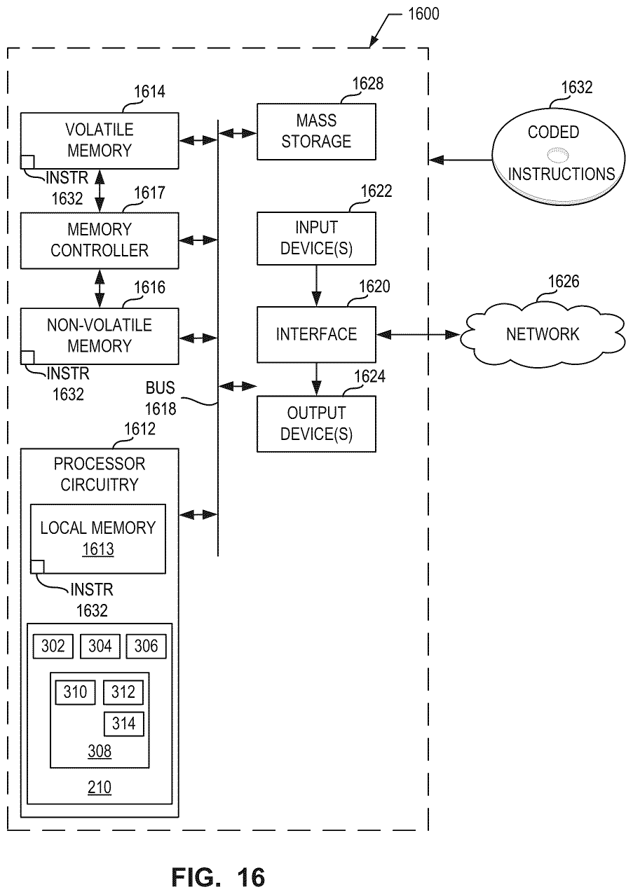

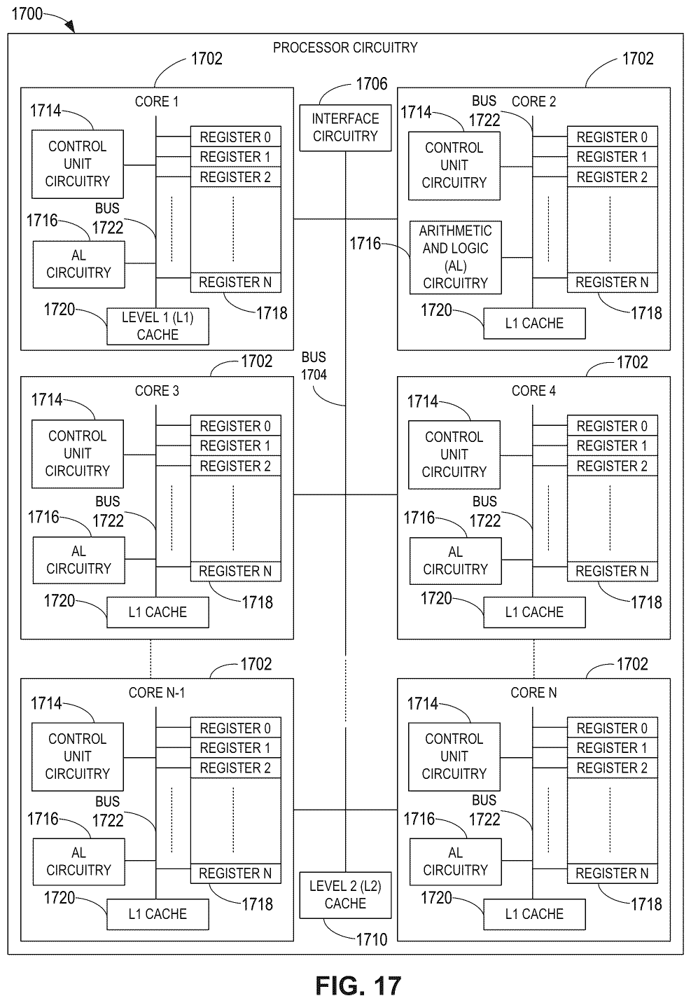

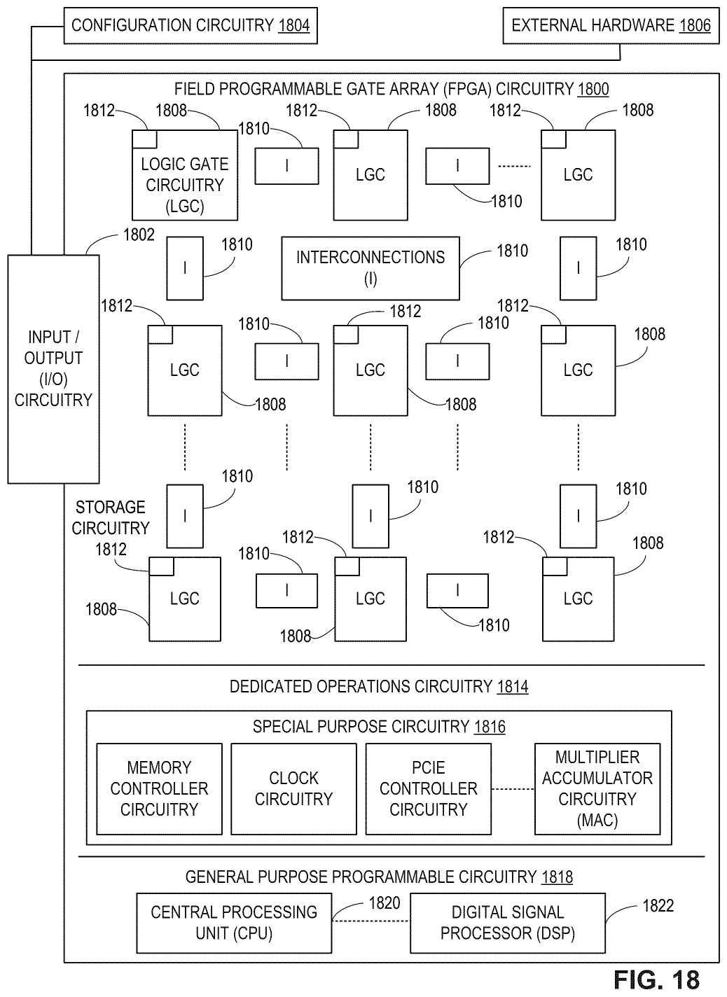

In some examples, the team classification circuitry 210 includes means for extracting features. For example, the means for extracting may be implemented by PIANet circuitry 304. In some examples, the PIANet circuitry 304 may be implemented by machine executable instructions such as that implemented by at least blocks 1106, 1202, 1204, 1206, 1208, 1210, 1212, 1214, 1216, 1218, 1220, 1302, 1304, 1306, 1308, 1310, 1312, 1314 of FIGS. 11-13 executed by processor circuitry, which may be implemented by the example processor circuitry 1612 of FIG. 16, the example processor circuitry 1700 of FIG. 17, and/or the example Field Programmable Gate Array (FPGA) circuitry 1800 of FIG. 18. In other examples, the PIANet circuitry 304 is implemented by other hardware logic circuitry, hardware implemented state machines, and/or any other combination of hardware, software, and/or firmware. For example, the PIANet circuitry 304 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example player association circuitry 306 matches players in pairs between frames in each one of the example camera(s) 104 of FIG. 1. In the illustrated example, the example player detection circuitry 302 tracks players with detected bounding boxes for example image data 300 from each one of the example camera(s) 104. In the illustrated example, the example PIANet circuitry 304 extracts features from the detection results of the player detection circuitry 302. The example player association circuitry 306 obtains the features from the example PIANet circuitry 304 and uses the extracted features to match players in pairs between frames of the example image data 300 from each one of the example camera(s) 104. In the illustrated example, the player association circuitry 306 calculates 3D positions of each player using the bounding boxes detected by the example player detection circuitry 302. The example player association circuitry 306 associates player bounding boxes of all example camera(s) 104 to calculate the 3D positions of the players. The example player association circuitry 306 performs a line-based correspondence method for person bounding boxes association. In the illustrated example, the player association circuitry 306 groups players in a ground plane of the example image data 300 and determines the player correspondence from multiple cameras (e.g., the example camera 104) using the line-based correspondence method. In the illustrated example, after the example player association circuitry 306 associates the player bounding boxes across the example camera(s) 104, the example player association circuitry 306 generates each players' position in a 3D space that is mapped to the 2D players in the example image data 300 from each camera view (e.g., the example views 106 of FIG. 1) of the example camera(s) 104.

In some examples, the team classification circuitry 210 includes means for grouping players. For example, the means for grouping may be implemented by player association circuitry 306. In some examples, the player association circuitry 306 may be implemented by machine executable instructions such as that implemented by at least blocks 1108, 1110 of FIG. 11 executed by processor circuitry, which may be implemented by the example processor circuitry 1612 of FIG. 16, the example processor circuitry 1700 of FIG. 17, and/or the example Field Programmable Gate Array (FPGA) circuitry 1800 of FIG. 18. In other examples, the player association circuitry 306 is implemented by other hardware logic circuitry, hardware implemented state machines, and/or any other combination of hardware, software, and/or firmware. For example, the player association circuitry 306 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example multi-camera team feature fusion circuitry 308 determines the team classifications and player classifications for each of the players in the example image data 300. The example multi-camera team feature fusion circuitry 308 adjusts a multi-class network to a two-class network to discriminate between two teams for each game. The example multi-camera team feature fusion circuitry 308 includes the example class score calculation circuitry 310, the example pairwise correlation calculation circuitry 312, and the example multi-camera voting score calculation circuitry 314 to determine the team classifications and player classifications for each player in the example image data 300 from the example camera(s) 104.

The example class score calculation circuitry 310 determines the example classes from the output of the example PIANet circuitry 304. In examples disclosed herein, the example classes are team classifications based on jersey appearances for the teams. The example class score calculation circuitry 310 determines the scores for each of the example classes based on the loss function outputs of the PIANet circuitry 304 for the example image data 300. In the illustrated example, the example multi-camera team feature fusion circuitry 308 abstracts a multi-class model into a two-class domain for a game. In some examples, there are several kinds of jersey styles (classes) that appear in a known game after jersey appearance grouping. However, for each game, there should only be two different sets of jersey (classes). Therefore, to discriminate between two teams during a game, the example multi-camera team feature fusion circuitry 308 selects the two classes with the smallest correlation scores from the output of the PIANet circuitry 304. The example class score calculation circuitry 310 determines the scores from the output of the PIANet circuitry 304 to determine the two classes to select. In examples disclosed herein, two classes are selected for a game based on two criteria: a selected class should be close to the team jersey in terms of feature similarity, and the two selected classes should be the most uncorrelated ones to have better discrimination characteristics.

The example pairwise correlation calculation circuitry 312 calculates correlation coefficients for pairs of classes to select the two classes with the smallest correlation scores from the output of the PIANet circuitry 304. The example pairwise correlation calculation circuitry 312 uses the associated player bounding box information from the example player association circuitry 306 and the class scores determined by the example class score calculation circuitry 310 from the output of the example PIANet circuitry 304. The example pairwise correlation calculation circuitry 312 calculates a correlation coefficient between each class pair using example Equation 1 below.

$${ρ}_{A , B} = \frac{cov ( A , B )}{{σ}_{A} {σ}_{B}} \qquad ( Equation 1 )$$

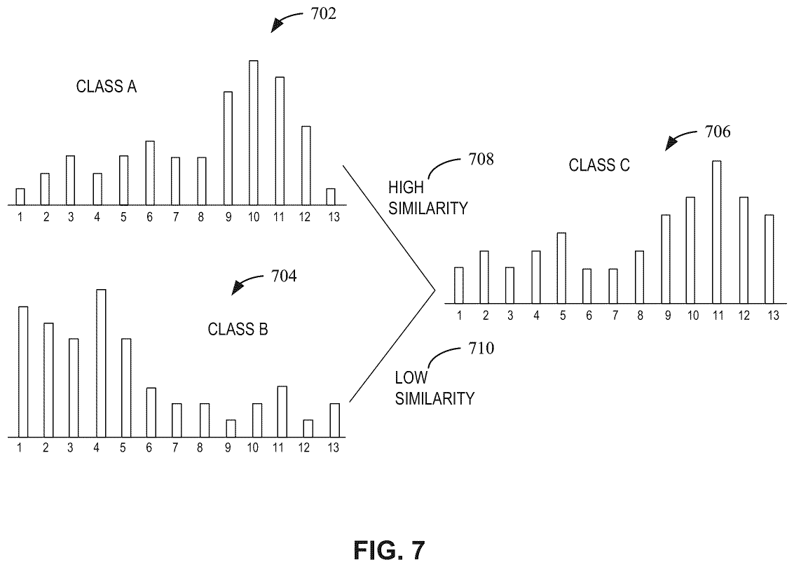

In the example Equation 1 above, ρ_{A,B} is the correlation coefficient for the pair of an example Class A and an example Class B, cov(A, B) is the covariance of the Class A and Class B, σ_{A} is the standard deviation of Class A, and σ_{B} is the standard deviation of Class B. In some examples, if the example pairwise correlation calculation circuitry 312 determines ρ_{A,B} is less than zero, then the example pairwise correlation calculation circuitry 312 determines the two classes (e.g., Class A and Class B) have a negative correlation. In some examples, if the example pairwise correlation calculation circuitry 312 determines ρ_{A,B} is greater than zero, then the example pairwise correlation calculation circuitry 312 determines the two classes (e.g., Class A and Class B) have a positive correlation. In examples disclosed herein, similar classes will have a higher correlation coefficient since the classes likely share a similar data distribution. An example of graphs from the example pairwise correlation calculation circuitry 312 comparing three example classes is illustrated in FIG. 7 below. The example pairwise correlation calculation circuitry 312 generates a matrix to record the pairwise correlation between all class pairs. In some examples, if the data distributions of two classes are similar, the example pairwise correlation calculation circuitry 312 excludes the two class from the candidate classes set. The example pairwise correlation calculation circuitry 312 compares the correlation coefficients between the pairs of classes and selects the two classes with the smallest correlation coefficient (e.g., lowest correlated classes) for classifying the players in the game.

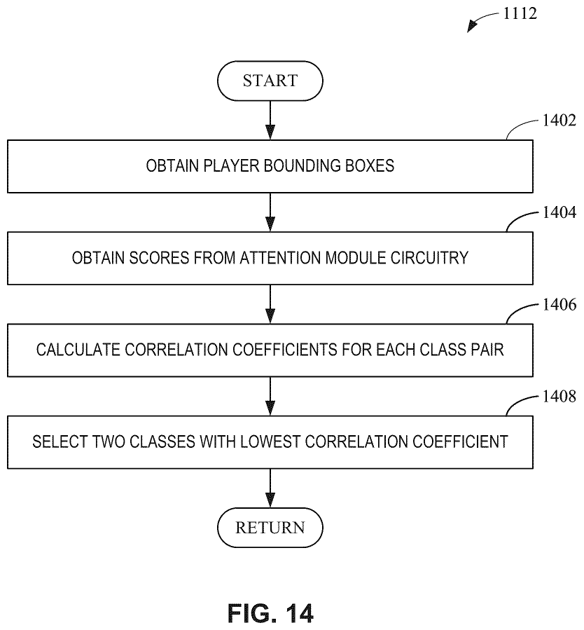

In some examples, the team classification circuitry 210 includes means for selecting lowest correlated classes. For example, the means for selecting may be implemented by pairwise correlation calculation circuitry 312. In some examples, the pairwise correlation calculation circuitry 312 may be implemented by machine executable instructions such as that implemented by at least blocks 1406, 1408 FIG. 14 executed by processor circuitry, which may be implemented by the example processor circuitry 1612 of FIG. 16, the example processor circuitry 1700 of FIG. 17, and/or the example Field Programmable Gate Array (FPGA) circuitry 1800 of FIG. 18. In other examples, the pairwise correlation calculation circuitry 312 is implemented by other hardware logic circuitry, hardware implemented state machines, and/or any other combination of hardware, software, and/or firmware. For example, the pairwise correlation calculation circuitry 312 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example, the example multi-camera voting score calculation circuitry 314 determine team labels for the player in the example image data 300 based on the two classes selected by the example pairwise correlation calculation circuitry 312. In some examples, due to the different angles of the camera views (e.g., the example views 106 of FIG. 1) of the example camera(s) 104 around the environment (e.g., the example environment 100), some player bounding boxes may appear very small and/or players may only be visible from one view (e.g., a side view) and not another (e.g., a front view). In such examples, a small sized bounding box will have weaker features than a larger sized bounding box, and team features between two players from a side view will be much less discriminative than from a front view. The example multi-camera voting score calculation circuitry 314 combines the team classification results from the different views of the example camera(s) 104 to output a team label for a player that is more accurate than relying on only one view from one of the example camera(s) 104. The example multi-camera voting score calculation circuitry 314 collects all player bounding boxes determined by the example player association circuitry 306, and for each bounding box associated with each player, the example multi-camera voting score calculation circuitry 314 divides the bounding boxes into two groups associated with the two selected classes. For each group of bounding boxes, the example multi-camera voting score calculation circuitry 314 calculates a voting score using example Equation 2 below.

$${score}_{team} = \frac{1}{3} {\sum }_{i = 1}^{N} ( {conf}_{c l a s s} + \frac{{area}_{b b o x}}{{max}_{allcamera} bbox} + \frac{{w}_{b b o x}}{{h}_{b b o x}} ) \qquad ( Equation 2 )$$

In the example Equation 2 above, conf_{class} is the classification confidence output from the example PIANet circuitry 304, area_{bbox} is an area of the current bounding box,

$${max}_{allcamera}$$

bbox is the area of the largest bounding box in the current frame across all camera views (e.g., the example views 106 of FIG. 1), w_{bbox} is the width of the current bounding box, and h_{bbox} is the height of the current bounding box. In the example Equation 2 above, the voting score is influenced by the confidence output because the larger the confidence, the more reliable the label is. The example Equation 2 above includes the area of the current bounding box because the larger the area of the bounding box, the more reliable and useful the features are from the bounding box. In the example Equation 2 above, the voting score is based on the width and height of the current bounding box for the cases when the image data from a camera looks at a player from a side view, which causes the bounding box to be relatively narrow compared to a frontal view. In the example Equation 2 above, the width and height of the bounding box represent the degree of player body deflection relative to the camera. The example multi-camera voting score calculation circuitry 314 determines the voting scores for both groups of bounding boxes using example Equation 2 above and determines which group has the higher voting score. The example multi-camera voting score calculation circuitry 314 determines the team classification label for players (e.g., uniformed personnel of interest) identified in the bounding boxes based on the group with the higher voting score. The example multi-camera voting score calculation circuitry 314 determines the final team labels for all players (e.g., uniformed personnel of interest) in the bounding boxes based on the voting score results and outputs the final team labels to the example results generator circuitry 212 of FIG. 2.

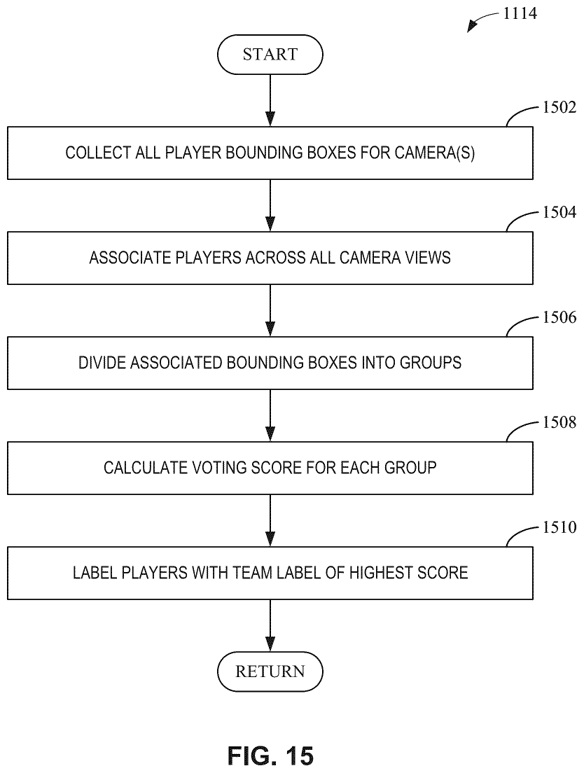

In some examples, the team classification circuitry 210 includes means for calculating voting scores for groups. For example, the means for calculating may be implemented by multi-camera voting score calculation circuitry 314. In some examples, the multi-camera voting score calculation circuitry 314 may be implemented by machine executable instructions such as that implemented by at least blocks 1502, 1504, 1506, 1508, 1510 of FIG. 15 executed by processor circuitry, which may be implemented by the example processor circuitry 1612 of FIG. 16, the example processor circuitry 1700 of FIG. 17, and/or the example Field Programmable Gate Array (FPGA) circuitry 1800 of FIG. 18. In other examples, the multi-camera voting score calculation circuitry 314 is implemented by other hardware logic circuitry, hardware implemented state machines, and/or any other combination of hardware, software, and/or firmware. For example, the multi-camera voting score calculation circuitry 314 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

FIG. 4 is a block diagram of the example pose-guided iterative attention network circuitry 304 included in the example team classification circuitry 210 of FIG. 3. The example PIANet circuitry 304 of FIG. 4 includes example input image data 402, an example first neural network layer 404, an example second neural network layer 406, an example third neural network layer 408, an example fourth neural network layer 410, example self-attention module circuitry 412A, 412B, 412C, example high-resolution net (HRNet) circuitry 414, example heatmap mask generator circuitry 418, example pixel-wise calculator circuitry 422, example classification loss calculator circuitry 424, example triplet loss calculation circuitry 426, and example loss calculator circuitry 428. In the illustrated example, the example PIANet circuitry 304 includes four neural network layers (e.g., the example first neural network layer 404, the example second neural network layer 406, the example third neural network layer 408, and the example fourth neural network layer 410) and three self-attention modules (e.g., the example self-attention module circuitry 412A, 412B, 412C). However, the example PIANet circuitry 304 can includes any number of neural network layers and/or self-attention modules.

In the illustrated example of FIG. 4, the example PIANet circuitry 304 includes two methods for extracting features from the image data (e.g., the example input image data 402). The first method in the example PIANet circuitry 304 is an iterative self-attention method that includes the example first neural network layer 404, the example second neural network layer 406, the example third neural network layer 408, the example fourth neural network layer 410, and the example self-attention module circuitry 412A, 412B, 412C. The second method in the example PIANet circuitry 304 is a pose-guided attention method that includes the example HRNet circuitry 414 and the example heatmap mask generator circuitry 418. In the illustrated example, the self-attention method of the example PIANet circuitry 304 (e.g., the example first neural network layer 404, the example second neural network layer 406, the example third neural network layer 408, the example fourth neural network layer 410, and the example self-attention module circuitry 412A, 412B, 412C) and the pose-guided attention method of the example PIANet circuitry 304 (e.g., the example HRNet circuitry 414 and the example heatmap mask generator circuitry 418) are run in parallel.

In the illustrated example of FIG. 4, the example PIANet circuitry 304 receives the example input image data 402. In some examples, the input image data 402 is the image data included in a player bounding box detected by the example player detection circuitry 302 of FIG. 3. The example PIANet circuitry 304 includes four sequential neural network layers (e.g., the example first neural network layer 404, the example second neural network layer 406, the example third neural network layer 408, and the example fourth neural network layer 410) to iteratively extract and focus features from the example input image data 402. In the illustrated example, each of the example first neural network layer 404, the example second neural network layer 406, the example third neural network layer 408, and the example fourth neural network layer 410 include a basic neural network layer that can be any kind of convolutional neural network (CNN) structure such as, for example, a bottleneck in Resnet a residual neural network (ResNet), etc.

In the illustrated example, the example first neural network layer 404 receives the example input image data 402. The example first neural network layer 404 extracts features from the example input image data 402. The example first neural network layer 404 transmits the input image data 402 and the extracted features to the second neural network layer 406 for deeper level feature extraction. The example first neural network layer 404 also transmits the input image data 402 and the extracted features to the self-attention module circuitry 412A to allow for feature focus on a torso region of a player included in the example input image data 402. The example second neural network layer 406 further extracts features from the example input image data 402. The example second neural network layer 406 transmits the input image data 402 and the extracted features to the third neural network layer 408 for deeper level feature extraction. The example second neural network layer 406 also transmits the input image data 402 and the extracted features to the self-attention module circuitry 412A to allow for feature focus on a torso region of a player included in the example input image data 402. The example third neural network layer 408 further extracts features from the example input image data 402. The example third neural network layer 408 transmits the input image data 402 and the extracted features to the fourth neural network layer 410 for deeper level feature extraction. The example third neural network layer 408 also transmits the input image data 402 and the extracted features to the self-attention module circuitry 412B to allow for further feature focus on a torso region of a player included in the example input image data 402. The example fourth neural network layer 410 further extracts features from the example input image data 402. The example fourth neural network layer 410 transmits the input image data 402 and the extracted features to the self-attention module circuitry 412C to allow for further feature focus on a torso region of a player included in the example input image data 402.

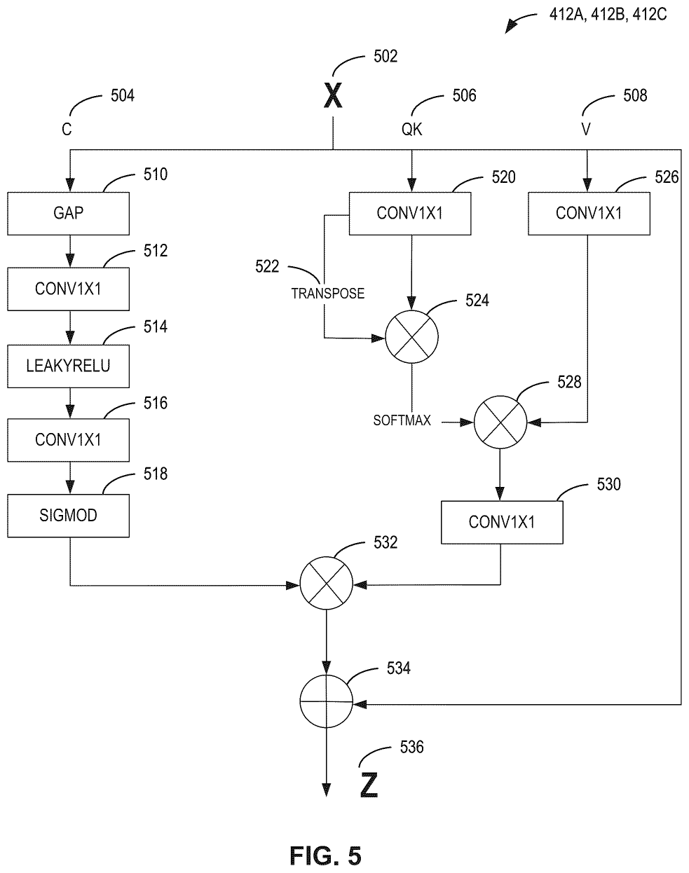

In the illustrated example of FIG. 4, each of the example first neural network layer 404, the example second neural network layer 406, and the example third neural network layer 408 send the input image data 402 and the extracted features to the next-level neural network layer for deeper level feature extractions. Additionally, each of the example first neural network layer 404, the example second neural network layer 406, the example third neural network layer 408, and the example fourth neural network layer 410 send the input image data 402 and the extracted features to respective self-attention module circuitry (e.g., self-attention module circuitry 412A, 412B, 412C) to allow for feature focus on the player torso region. In the illustrated example, each of the self-attention module circuitry 412A, 412B, 412C iteratively identify the player torso region in the example input image data 402 and focus the extracted features from the respective neural network layers (e.g., the example first neural network layer 404, the example second neural network layer 406, the example third neural network layer 408, and the example fourth neural network layer 410) in the identified region. Each of the example self-attention module circuitry 412A, 412B, 412C concatenate raw features from the respective neural network layers (e.g., the example first neural network layer 404, the example second neural network layer 406, the example third neural network layer 408, and the example fourth neural network layer 410) and the features after running the self-attention module circuitry 412A, 412B, 412C in the channel dimension. Each of the example self-attention module circuitry 412A, 412B, 412C determine the features in the identified player torso region both in the channel and spatial dimensions. The example self-attention module circuitry 412A, 412B, 412C are described in further detail below in connection with FIG. 5.

In some examples, the jerseys in sports games are diversified, and the background environment (e.g., the example environment 100 of FIG. 1) can change dynamically between different games (e.g., due to illumination, weather, etc.). In such examples, the iterative self-attention method of the example PIANet circuitry 304 (e.g., the example first neural network layer 404, the example second neural network layer 406, the example third neural network layer 408, the example fourth neural network layer 410, and the example self-attention module circuitry 412A, 412B, 412C) may not cover every case of features from changes in jerseys and the background environment. In the illustrated example, the pose-guided attention method of the example PIANet circuitry 304 (e.g., the example HRNet circuitry 414 and the example heatmap mask generator circuitry 418) further enhances the iterative self-attention method by guiding the feature focus on a relevant region the input image data 402 (e.g., an upper torso region).

In the illustrated example of FIG. 4, when the example PIANet circuitry 304 receives the example input image data 402, the example PIANet circuitry 304 transmits the input image data 402 to the example HRNet circuitry 414. The example HRNet circuitry 414 analyzes the example input image data 402 and estimates different body landmarks of a player included in the input image data 402 to generate an upper pose 416 of the example input image data 402. The example HRNet circuitry 414 localizes human anatomical key points/parts in the example input image data 402 to estimate the body landmarks of the player in the example upper pose 416. In some examples, the HRNet circuitry 414 can estimate 14 body landmarks. However, the example HRNet circuitry 414 can estimate any number of body landmarks from the example input image data 402. In the illustrated example, the HRNet circuitry 414 localizes an upper torso area/region (e.g., referred to as Sᵤₜ). The example HRNet circuitry 414 localizes the upper torso region (Sᵤₜ) using four estimated landmarks (e.g., left shoulder, right shoulder, right hip, and left hip) from the example upper pose 416 and determining a quadrilateral area enclosed by the four identified landmarks. The example HRNet circuitry 414 calculates the geometric center (e.g., referred to as C) of the upper torso region (Sᵤₜ) in the example input image data 402. The example HRNet circuitry 414 determines a distance (e.g., referred to as R) from the geometric center (C) of the upper torso region (Sᵤₜ) to the farthest estimated landmark.

The example heatmap mask generator circuitry 418 generates a heatmap mask 420 for the example input image data 402. The example heatmap mask generator circuitry 418 generates the heatmap mask 420 to conform to a Gaussian distribution where geometric center and the upper torso region are equal (e.g., C=Sᵤₜ) and a delta function is equal to the distance from the geometric center of the upper torso region to the farthest estimated landmark (e.g., δ=R). In some examples, the heatmap mask generator circuitry 418 sets the points beyond the gaussian kernel to a value of zero. The example heatmap mask generator circuitry 418 scales the generated heatmap mask 420 to be consistent with the output size from the iterative self-attention method of the example PIANet circuitry 304 (e.g., the example first neural network layer 404, the example second neural network layer 406, the example third neural network layer 408, the example fourth neural network layer 410, and the example self-attention module circuitry 412A, 412B, 412C). In some examples, the heatmap mask generator circuitry 418 scales heatmap mask 420 to 1/8. However, the heatmap mask generator circuitry 418 can scale the heatmap mask 420 by any number to be consistent with the output size of the iterative self-attention method of the example PIANet circuitry 304.

In the illustrated example of FIG. 4, the example pixel-wise calculator circuitry 422 calculates a pixel-wise L2 loss between a feature that is estimated by the example iterative self-attention method of the example PIANet circuitry 304 (e.g., the example first neural network layer 404, the example second neural network layer 406, the example third neural network layer 408, the example fourth neural network layer 410, and the example self-attention module circuitry 412A, 412B, 412C) and the generated heatmap mask 420 from the example heatmap mask generator circuitry 418. The example pixel-wise calculator circuitry 422 calculates the pixel-wise L2 loss to guide the iterative self-attention method of the example PIANet circuitry 304 in a supervised way. The example classification loss calculator circuitry 424 calculates a cross-entropy loss based on the feature that is estimated by the example iterative self-attention method of the example PIANet circuitry 304. The example classification loss calculator circuitry 424 calculates the cross-entropy loss to guide the classification performance between the feature and the determined classes. The example triplet loss calculation circuitry 426 calculates a triplet loss based on the feature that is estimated by the example iterative self-attention method of the example PIANet circuitry 304. The example triplet loss calculation circuitry 426 calculates the triplet loss to reduce an intra-class distance between the classes of the PIANet circuitry 304 and increase the discrimination between the classes. The example pixel-wise calculator circuitry 422, the example classification loss calculator circuitry 424, and the example triplet loss calculation circuitry 426 calculate different kinds of losses to allow the example PIANet circuitry 304 to perform classification of the focused feature based on the feature output by the example self-attention module circuitry 412C in the example iterative self-attention method of the example PIANet circuitry 304 and the heatmap mask 420 generated by the example heatmap mask generator circuitry 418.

The example loss calculator circuitry 428 determines a final loss function based on the losses determined by the example pixel-wise calculator circuitry 422, the example classification loss calculator circuitry 424, and the example triplet loss calculation circuitry 426. The example loss calculator circuitry 428 determines the final loss function using example Equation 3 below.

loss_{PIA}=loss_{CE}+αlossₜᵣᵢₚₗₑₜ+βloss_{pixel-wise} (Equation 3)

In the example Equation 3 above, the loss_{CE} is the cross-entropy loss calculated by the example classification loss calculator circuitry 424, the lossₜᵣᵢₚₗₑₜ is the triplet loss calculated by the example triplet loss calculation circuitry 426, and the loss_{pixel-wise} is the pixel-wise L2 loss calculated by the example pixel-wise calculator circuitry 422. In the example Equation 3, the a is a weighting parameter for the triplet loss (lossₜᵣᵢₚₗₑₜ) and the is a weighting parameter for the pixel-wise L2 loss (loss_{pixel-wise}) In the example Equation 3, the α and β weighting parameters control the impact of the respective losses (e.g., lossₜᵣᵢₚₗₑₜ and loss_{pixel-wise}) in the overall loss function. In some examples, the α and β weighting parameters are preset with empirical numbers and can be fine-tuned by the example loss calculator circuitry 428. In some examples, the loss calculator circuitry 428 uses the final loss function to determine scores for classifications between the features from the example input image data 402 and the class of the PIANet circuitry 304.

FIG. 5 is a flow diagram of example self-attention module circuitry 412A, 412B, 412C included in the example pose-guided iterative attention network (PIANet) circuitry 304 of FIG. 4. In the illustrated example, the self-attention module circuitry 412A, 412B, 412C receive inputs 502 from respective neural network layers and self-attention module circuitry included in the example PIANet circuitry 304. For example, the example self-attention module circuitry 412A receives inputs from the example first neural network layer 404 and the example second neural network layer 406, while also sharing inputs from the example self-attention module circuitry 412B, the example self-attention module circuitry 412B receives inputs from the example third neural network layer 408 while also sharing inputs from the example self-attention module circuitry 412A and 412C, and the example self-attention module circuitry 412C receives inputs from the example fourth neural network layer 410 while also sharing inputs from the example self-attention module circuitry 412B.

The example self-attention module circuitry 412A, 412B, 412C include a first branch 504 (e.g., labelled “C”), which analyzes the example inputs 502 in the channel dimension. In the illustrated example, the self-attention module circuitry 412A, 412B, 412C also include a second branch 506 (e.g., labelled “QK”) and a third branch 508 (e.g., labelled “V”), which analyze the example inputs 502 in the spatial dimension.

In the example first branch 504, the example self-attention module circuitry 412A, 412B, 412C performs a global maximum pooling 510 of the input features from the example inputs 502. The example self-attention module circuitry 412A, 412B, 412C performs a 1×1 convolution 512 to compress the input features to scale of 1/r, where r is a numerical value of the scale. The example self-attention module circuitry 412A, 412B, 412C applies a leaky rectified linear unit (Leaky ReLU) function 514 to the input features to nonlinearly activate the outputs. The example self-attention module circuitry 412A, 412B, 412C performs a 1×1 convolution 516 to recover the feature channels to be equal to the number of inputs 502. Finally, in the example first branch 504, the example self-attention module circuitry 412A, 412B, 412C applies a sigmoid function 518 to normalize the output of 1×1 convolution 516 corresponding to the weight of each channel.

In the illustrated example of FIG. 5, the example second branch 506 and the example third branch 508 are a transformer mechanism in the natural language processing (NLP) domain. In the illustrated example, the query and key are compressed in the second branch 506, which achieve the same effect as separate query and key with relatively few parameters. In the example second branch 506, the example self-attention module circuitry 412A, 412B, 412C performs a 1×1 convolution 520 on the inputs 502 to scale the features to ¼ size of the inputs 502. However, the example self-attention module circuitry 412A, 412B, 412C can perform the 1×1 convolution 520 to scale the features to any fraction of the size of the inputs 502. The example self-attention module circuitry 412A, 412B, 412C transposes 522 the output of the 1×1 convolution 520. The example self-attention module circuitry 412A, 412B, 412C multiplies 524 the output of the 1×1 convolution 520 and the transposed output 522 to obtain a self-correlation factor to highlight an informative region.

In the example third branch 508, the example self-attention module circuitry 412A, 412B, 412C also performs a 1×1 convolution 526 on the inputs 502. The example self-attention module circuitry 412A, 412B, 412C multiplies 528 the output self-correlation factor of the example second branch 506 and the output of the example third branch 508. In the illustrated example, the example self-attention module circuitry 412A, 412B, 412C performs a 1×1 convolution 530 to reshape the output from the multiplication 528 to a height by width by channel (HxWxC) that matches with the channel number of the example inputs 502. The example self-attention module circuitry 412A, 412B, 412C then multiplies 532 the output of the example first branch 504 with the reshaped output from 1×1 convolution 530 in the channel dimension. The example self-attention module circuitry 412A, 412B, 412C uses the multiplication 532 to combine the features of the channel dimension (from the example first branch 504) and the features of the spatial dimension (from the example second branch 506 and the example third branch 508)

In the illustrated example of FIG. 5, each of the example self-attention module circuitry 412A, 412B, 412C determine the extracted features in a channel dimension via the example first branch 504 by performing global maximum pooling on the extracted features, compressing the extracted features via convolution, performing a leaky ReLU function, recovering feature channels to match the number of channel in the input, and normalizing the extracted features with sigmoid function. Additionally, each of the example self-attention module circuitry 412A, 412B, 412C determine the extracted features in a spatial dimension via the example second branch 506 and the example third branch 508 by scaling the extracted features to a fourth size of the example inputs 502, transposing the extracted features, determining a self-correlation factor by multiplying the scaled extracted features by the transposed extracted features, multiplying the self-correlation factor by convolution of the extracted features, and performing convolution to match the channel number of the extracted features and the channel number of the example inputs 502. In the illustrated example, the example self-attention module circuitry 412A, 412B, 412C focus the extracted features in an upper torso region by combining the extracted features in the channel dimension and the extracted features in the spatial dimension.

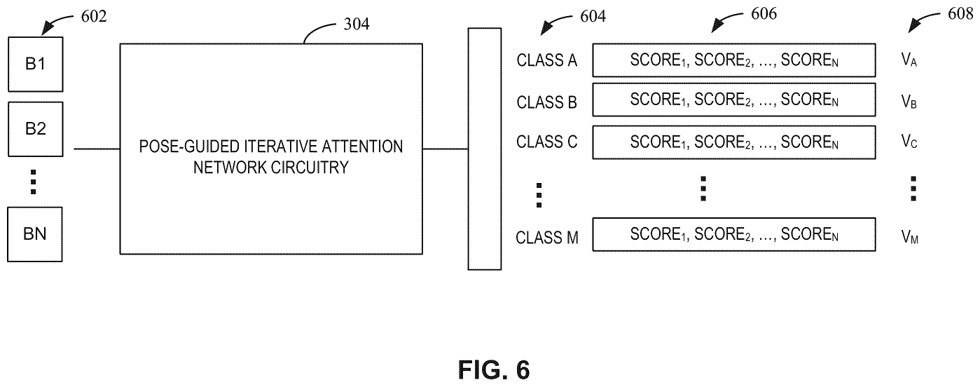

FIG. 6 illustrates a diagram of example inputs and output feature vectors of the example team classification circuitry 210 of FIGS. 2 and/or 3. The illustrated example of FIG. 6 includes input batch images 602 collected at the beginning of a sports game by the example camera(s) 104 of FIG. 1. The PIANet circuitry 304 receives the example input batch images 602 from the example camera interface(s) 208 of FIG. 2. In the illustrated example, the PIANet circuitry 304 extracts features from the input batch images 602 to determine similarities between the extracted features and a predetermined lists of classes 604. The PIANet circuitry 304 compares the extracted features from each of the input batch images 602 and compares them with features of each of the classes from the list of classes 604 to determine example scores 606 of the similarities between the features. In the illustrated example, each of the classes in the list of classes 604 is associated with a vector of scores 606. In the illustrated example, the PIANet circuitry 304 determines a score for each combination of the classes and the input batch images 602. In the illustrated example of FIG. 3, the output scores 606 for each of the classes in the list of classes 604 are used by the example class score calculation circuitry 310 of FIG. 3 to generate feature vectors 608 (e.g., Vₐ−Vₘ) that are filled with the scores 606 of each input batch image 602. Example feature vectors determined by the example class score calculation circuitry 310 are also illustrated below in connection with FIG. 7.

FIG. 7 is a schematic of example graphs 702, 704, 706 from comparisons of three example classes in accordance with teachings of this disclosure. In the illustrated example, the graph 702 illustrates an example feature vector for a first class (e.g., Class A), the graph 704 illustrates an example feature vector for a second class (e.g., Class B), and the graph 706 illustrates an example feature vector for a third class (e.g., Class C). In some examples, the example class score calculation circuitry 310 of FIG. 3 generates the feature vectors illustrated in the graphs 702, 704, 706. In the illustrated example, the horizontal axis of the graphs 702, 704, 706 represent the input player bounding box identifiers determined by the example player association circuitry 306 of FIG. 3. The vertical axis of the graphs 702, 704, 706 illustrate the output scores of the similarity in features between the class and the individual input player bounding boxes as determined by the example PIANet circuitry 304 of FIG. 3. In the illustrated example, the correlation coefficients for each class pair (e.g., class pair A and B, class pair A and C, and class pair B and C) are determined by the example pairwise correlation calculation circuitry 312 of FIG. 3 using example Equation 1, as described above. In the illustrated example, the pairwise correlation calculation circuitry 312 determines there is a high similarity 708 between Class A in graph 702 and Class C in graph 706. In the illustrated example, the pairwise correlation calculation circuitry 312 determines there is a low similarity 710 between Class B in graph 704 and Class C in graph 706. The feature vectors for each class (e.g., the feature vectors illustrated in the graphs 702, 704, 706) are compared by the example pairwise correlation calculation circuitry 312 to determine the correlation coefficients for each class pair.

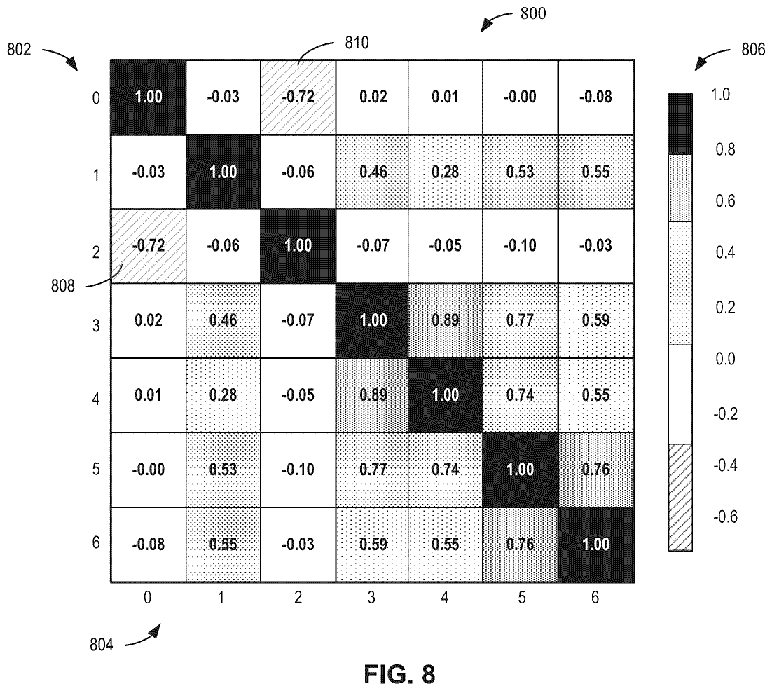

FIG. 8 is an example table 800 of example correlation coefficients between pairs of classes in accordance with teachings of this disclosure. In the illustrated example, the pairwise correlation calculation circuitry 312 of FIG. 3 generates the table 800 with the calculated correlation coefficients for the pairs of classes. The example table 800 includes a vertical axis 802 and a horizontal axis 804 that include the list of classes (e.g., identified as 0-6 in the example table 800) to generate the matrix of correlation coefficients. In the illustrated example, the table 800 includes an example matrix key 806 that illustrates a range of color variations representing the range of values for the correlation coefficient. In the illustrated example, the matrix key 806 includes a range of 1.0 to −0.6 for the values of the correlation coefficients. In some examples, the matrix key 806 can change based on the correlation coefficients determined by the pairwise correlation calculation circuitry 312. In table 800, the matrix key 806 indicates that a darker color in the table 800 represents a higher correlation coefficient between the two classes, and a lighter color in the table 800 represented a lower correlation coefficient between the two classes. In the illustrated example, the pairwise correlation calculation circuitry 312 identifies the lowest correlation coefficients in the table 800, which are the example correlation coefficient 808 and the example correlation coefficient 810. In table 800, the correlation coefficient 808 and the correlation coefficient 810 are representative of the relationship between Class 0 and Class 2 in the table 800. In the illustrated example, the pairwise correlation calculation circuitry 312 selects Class 0 and Class 2 for the specific sports game as the two teams the players are sorted into by the example multi-camera voting score calculation circuitry 314 of FIG. 3.

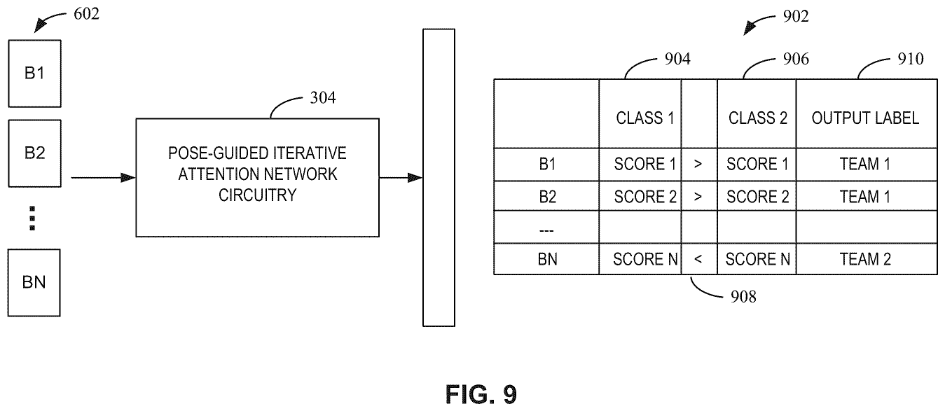

FIG. 9 is a block diagram of example inputs and output classifications of the example team classification circuitry 210 of FIGS. 2 and/or 3. The illustrated example of FIG. 9 includes the example input batch images 602 collected at the beginning of a sports game by the example camera(s) 104 of FIG. 1. The PIANet circuitry 304 receives the example input batch images 602 from the example camera interface(s) 208 of FIG. 2, and the PIANet circuitry 304 compares extracted features from the input batch images 602 with features of predetermined classes to determines scores for the similarities between the input batch images 602 and each of the classes. In the illustrated example, the pairwise correlation calculation circuitry 312 of FIG. 3 uses the feature vectors determined by the example class score calculation circuitry 310 of FIG. 3 from the output scores of the PIANet circuitry 304 to determine correlation coefficients between pairs of classes. The pairwise correlation calculation circuitry 312 selects a first class (e.g., Class 1) and a second class (e.g., Class 2) that have the lowest correlation coefficient as representing the two teams in the sports game. In the illustrated example, an example table 902 includes a first column 904 associated with the first selected class (e.g., Class 1) and a second column 906 associated with the second selected class (e.g., Class 2). In the illustrated example, the multi-camera voting score calculation circuitry 314 of FIG. 3 determines voting scores for the first selected class and the second selected class for each of the input batch images 602 using example Equation 3, as described above in connection with FIG. 3. The multi-camera voting score calculation circuitry 314 populates the first column 904 and the second column 906 with the determined voting scores. In the illustrated example of FIG. 9, the multi-camera voting score calculation circuitry 314 compares the scores in the first column 904 and the scores in the second column 906 for each input batch image 602 to make comparison determinations 908 (e.g., greater than or less than). Based on the comparison determination 908, the multi-camera voting score calculation circuitry 314 determines the output labels 910 for each of the input batch image 602. In the illustrated example, the output labels 910 are the two teams associated with the first selected class and the second selected class, respectively.

FIGS. 10A, 10B illustrate example graphics 1000, 1010 from the classification results of the example team classification circuitry 210 of FIGS. 2 and/or 3. In the illustrated examples, the graphic 1000 of FIG. 10A illustrates classification results for a football game (e.g., an NFL game), and the graphic 1010 of FIG. 10B illustrates classification results (e.g., the example team classification results 214 of FIG. 2) for a soccer game (e.g., a FIFA game). In the illustrated example of FIGS. 10A and 10B, the graphic 1000 and the graphic 1010 include team labels on each of the players included in the graphics 1000, 1010. For example, an example first team label 1002 and an example second team label 1004 are illustrated in the graphic 1000, and an example third team label 1012 and an example fourth team label 1014 are illustrated in the graphic 1010. In the illustrated example of FIG. 10A, the first team label 1002 is associated with a first team in the football game and the second team label 1004 is associated with a second team in the football game. In the illustrated example of FIG. 10B, the third team label 1012 is associated with a first team in the soccer game and the fourth team label 1014 is associated with a second team in the soccer game. In the illustrated examples, the players in the graphic 1000 and the graphic 1010 include team labels that are associated either with the first team or the second team for the respective sports games (e.g., the football game and the soccer game). In the illustrated examples of FIGS. 10A, 10B, the graphic 1000 and the graphic 1010 illustrate the outputs of the classifications determined by the example multi-camera voting score calculation circuitry 314 of FIG. 3. The team labels (e.g., the example first team label 1002, the example second team label 1004, the example third team label 1012, and the example fourth team label 1014) are generated by the example results generator circuitry 212 based on the results from the example multi-camera voting score calculation circuitry 314 determining which team (e.g., either the first team or the second team) each of the players belong to for the respective sports games.

While an example manner of implementing the example team classification circuitry 210 of FIG. 2 is illustrated in FIG. 3, one or more of the elements, processes, and/or devices illustrated in FIG. 3 may be combined, divided, re-arranged, omitted, eliminated, and/or implemented in any other way. Further, the example player detection circuitry 302, the example pose-guided iterative attention network circuitry 304, the example player association circuitry 306, the example multi-camera team feature fusion circuitry 308, the example class score calculation circuitry 310, the example pairwise correlation calculation circuitry 312, the example multi-camera voting score calculation circuitry 314, and/or, more generally, the example team classification circuitry 210 of FIGS. 2 and 3, may be implemented by hardware alone or by hardware in combination with software and/or firmware. Thus, for example, any of the example player detection circuitry 302, the example pose-guided iterative attention network circuitry 304, the example player association circuitry 306, the example multi-camera team feature fusion circuitry 308, the example class score calculation circuitry 310, the example pairwise correlation calculation circuitry 312, the example multi-camera voting score calculation circuitry 314, and/or, more generally, the example team classification circuitry 210, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example team classification circuitry 210 of FIGS. 2 and 3 may include one or more elements, processes, and/or devices in addition to, or instead of, those illustrated in FIG. 3, and/or may include more than one of any or all of the illustrated elements, processes and devices.

Flowcharts representative of example hardware logic circuitry, machine readable instructions, hardware implemented state machines, and/or any combination thereof for implementing the team classification circuitry 210 of FIG. 3 are shown in FIGS. 11-15. The machine readable instructions may be one or more executable programs or portion(s) of an executable program for execution by processor circuitry, such as the processor circuitry 1612 shown in the example processor platform 1600 discussed below in connection with FIG. 16 and/or the example processor circuitry discussed below in connection with FIGS. 17 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 11-15, many other methods of implementing the example team classification circuitry 210 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 11-15 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 11 is a flowchart representative of example machine readable instructions and/or example operations 1100 that may be executed and/or instantiated by processor circuitry to implement the example team analysis circuitry 206 of FIG. 2 and the example team classification circuitry 210 of FIGS. 2 and/or 3. The machine readable instructions and/or operations 1100 of FIG. 11 begin at block 1102, at which the example camera interface(s) 208 obtains the image data (e.g., the example image data 300 of FIG. 3) from the example camera(s) 104. In some examples, the camera interface(s) 208 receives the image/video data (e.g., the example image data 300) collected by the example camera(s) 104 via the example network 204 of FIG. 2. In some examples, the camera interface(s) 208 collects the video/image data (e.g., the example image data 300) respectively from each of the example camera(s) 104.

At block 1104, the example player detection circuitry 302 detects players from the image data for each of the camera(s) 104. In some examples, the example player detection circuitry 302 removes any non-sport field area from the example image data 300 using a pre-defined court mask. In some examples, the player detection circuitry 302 detects all players in a play field of the example image data. In some examples, the player detection circuitry 302 detects the players using a person detection algorithm such as, for example, You Only Look Once (YOLO), Single Short MultiBox Detector (SSD), Fast Region Based Convolutional Neural Networks (Fast-RCNN), etc. The example player detection circuitry 302 determines bounding boxes for the detected players. In some examples, the example player detection circuitry 302 labels the bounding boxes with identifiers (e.g., numbers, letters, etc.) that identify each player bounding box. The example player detection circuitry 302 transmits the detected player information in the example image data to the example PIANet circuitry 304.

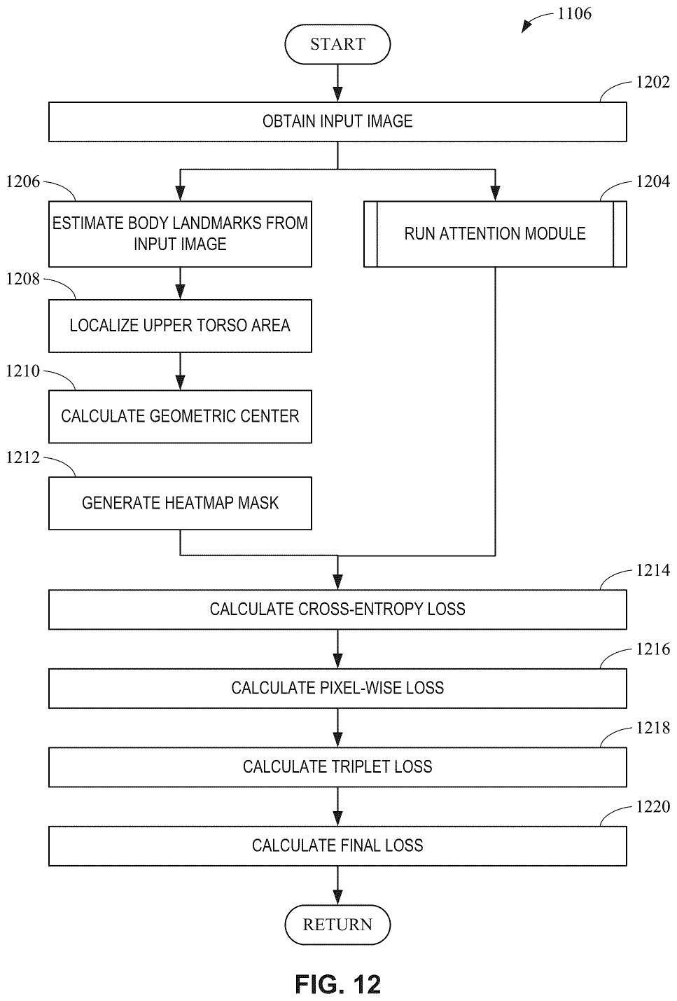

At block 1106, the example PIANet circuitry 304 performs team feature extraction for each of the camera(s) 104. In some examples, the example PIANet circuitry 304 extracts features from the example image data for the detected players identified by the example player detection circuitry 302. In some examples, the PIANet circuitry 304 extracts features from the example image data using sequential neural network layers. The example PIANet circuitry 304 identifies the extracted features in an upper torso region of the detected player using self-attention modules in parallel with each of the sequential neural network layers. The example PIANet circuitry 304 determines an upper heatmap mask in parallel to the sequential neural network layers based on the example image data to localize the features on the relevant region of an upper torso of the player. The example PIANet circuitry 304 calculates a loss function for the example image data 300 based on different losses determined from the focused extracted features and generated heatmap mask. As described in further detail below, the example flowchart 1106 of FIG. 12 represents example instructions that may be implemented to perform team feature extraction for each of the camera(s) 104.

At block 1108, the example player association circuitry 306 tracks the players in the image data for each of the example camera(s) 104 to determine bounding boxes. In some examples, the example player association circuitry 306 matches players in pairs between frames in each one of the example camera(s) 104. In some examples, the example player detection circuitry 302 tracks players with detected bounding boxes for example image data from each one of the example camera(s) 104. The example player association circuitry 306 obtains the features from the example PIANet circuitry 304 and uses the extracted features to match players in pairs between frames of the example image data from each one of the example camera(s) 104. In some examples, the player association circuitry 306 calculates 3D positions of each player using the bounding boxes detected by the example player detection circuitry 302.

At block 1110, the example player association circuitry 306 performs multi-camera player association. In some examples, the example player association circuitry 306 associates player bounding boxes of all example camera(s) 104 to calculate the 3D positions of the players. The example player association circuitry 306 performs a line-based correspondence method for person bounding boxes association. In some examples, the player association circuitry 306 groups players in a ground plane of the example image data 300 and determines the player correspondence from multiple cameras (e.g., the example camera 104) using the line-based correspondence method. In some examples, after the example player association circuitry 306 associates the player bounding boxes across the example camera(s) 104, the example player association circuitry 306 generates each players' position in a 3D space that is mapped to the 2D players in the example image data 300 from each camera view (e.g., the example views 106 of FIG. 1) of the example camera(s) 104.

At block 1112, the example multi-camera team feature fusion circuitry 308 performs significant class selection. In some examples, the example multi-camera team feature fusion circuitry 308 determines the team classifications and player classifications for each of the players in the example image data by determining significant class selection. As described in further detail below, the example flowchart 1112 of FIG. 14 represents example instructions that may be implemented to perform significant class selection.

At block 1114, the example multi-camera team feature fusion circuitry 308 performs multi-camera team feature fusion. In some examples, the example multi-camera team feature fusion circuitry 308 adjusts a multi-class network to a two-class network to discriminate between two teams for each game. As described in further detail below, the example flowchart 1114 of FIG. 15 represents example instructions that may be implemented to perform multi-camera team feature fusion. At block 1116, the example multi-camera team feature fusion circuitry 308 outputs the final player team label. After block 1116 completes, process 1100 ends.

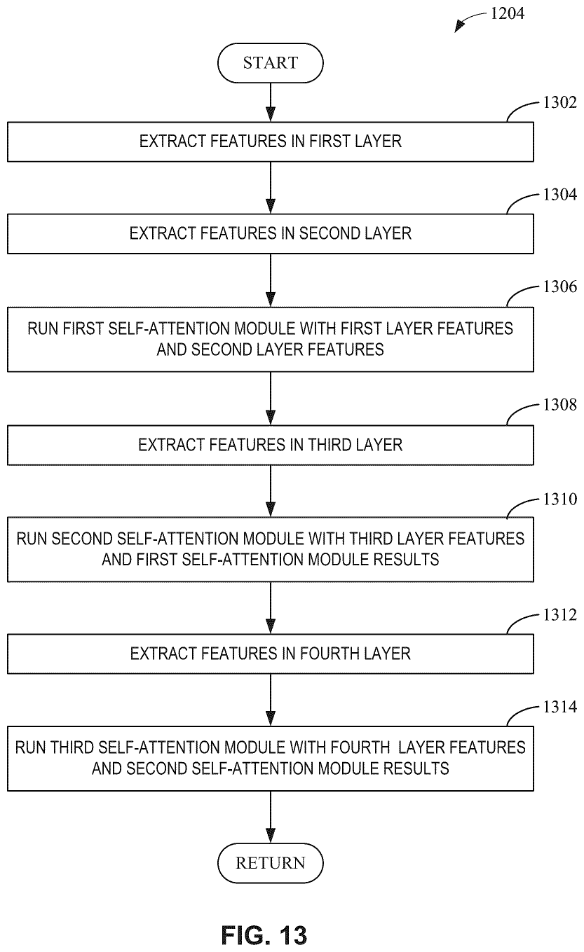

FIG. 12 is a flowchart representative of example machine readable instructions and/or example operations 1106 that may be executed and/or instantiated by processor circuitry to implement the example PIANet circuitry 304 included in the example team classification circuitry 210 of FIGS. 2, 3, and/or 4. The machine readable instructions and/or operations 1106 of FIG. 12 begin at block 1202, at which the example PIANet circuitry 304 obtains the input image. At block 1204, the example PIANet circuitry 304 runs the attention module. In some examples, the example PIANet circuitry 304 iteratively runs the attention module to extract features from the image data. As described in further detail below, the example flowchart 1204 of FIG. 13 represents example instructions that may be implemented to run the attention module.

At block 1206, the example HRNet circuitry 414 estimates body landmarks from the input image. In some examples, the example HRNet circuitry 414 analyzes the input image data and estimates different body landmarks of a player included in the input image to generate an upper pose of the example input image. At block 1208, the example HRNet circuitry 414 localizes an upper torse area. In some examples, the example HRNet circuitry 414 localizes human anatomical key points/parts in the example input image to estimate the body landmarks of the player in the example upper pose. In some examples, the HRNet circuitry 414 can estimate 14 body landmarks. However, the example HRNet circuitry 414 can estimate any number of body landmarks from the example input image. In the illustrated example, the HRNet circuitry 414 localizes an upper torso area/region (e.g., referred to as Sᵤₜ). The example HRNet circuitry 414 localizes the upper torso region (Sᵤₜ) using four estimated landmarks (e.g., left shoulder, right shoulder, right hip, and left hip) from the example upper pose and determining a quadrilateral area enclosed by the four identified landmarks.

At block 1210, the example HRNet circuitry 414 calculates a geometric center. In some examples, the example HRNet circuitry 414 calculates the geometric center (e.g., referred to as C) of the upper torso region (Sᵤₜ) in the example input image. The example HRNet circuitry 414 determines a distance (e.g., referred to as R) from the geometric center (C) of the upper torso region (Sᵤₜ) to the farthest estimated landmark.

At block 1212, the example heatmap mask generator circuitry 418 generates a heatmap mask. In some examples, the example heatmap mask generator circuitry 418 generates a heatmap mask for the example input image. The example heatmap mask generator circuitry 418 generates the heatmap mask to conform to a Gaussian distribution where geometric center and the upper torso region are equal (e.g., C=Sᵤₜ) and a delta function is equal to the distance from the geometric center of the upper torso region to the farthest estimated landmark (e.g., δ=R). In some examples, the heatmap mask generator circuitry 418 sets the points beyond the gaussian kernel to a value of zero. The example heatmap mask generator circuitry 418 scales the generated heatmap mask to be consistent with the output size from the iterative attention module of the example PIANet circuitry 304. In some examples, the heatmap mask generator circuitry 418 scales heatmap mask 420 to ⅛. However, the heatmap mask generator circuitry 418 can scale the heatmap mask 420 by any number to be consistent with the output size of the iterative attention module of the example PIANet circuitry 304.

At block 1214, the example classification loss calculator circuitry 424 calculates a cross-entropy loss. In some example, the example classification loss calculator circuitry 424 calculates a cross-entropy loss based on the feature that is estimated by the example attention module of the example PIANet circuitry 304. The example classification loss calculator circuitry 424 calculates the cross-entropy loss to guide the classification performance between the feature and the determined classes.

At block 1216, the example pixel-wise calculator circuitry 422 calculates a pixel-wise loss. In some examples, the example pixel-wise calculator circuitry 422 calculates a pixel-wise L2 loss between a feature that is estimated by the example attention module of the example PIANet circuitry 304 and the generated heatmap mask from the example heatmap mask generator circuitry 418. The example pixel-wise calculator circuitry 422 calculates the pixel-wise L2 loss to guide the attention module of the example PIANet circuitry 304 in a supervised way.

At block 1218, the example triplet loss calculation circuitry 426 calculates a triplet loss. In some examples, the example triplet loss calculation circuitry 426 calculates a triplet loss based on the feature that is estimated by the example attention module of the example PIANet circuitry 304. The example triplet loss calculation circuitry 426 calculates the triplet loss to reduce an intra-class distance between the classes of the PIANet circuitry 304 and increase the discrimination between the classes.

At block 1220, the example loss calculator circuitry 428 calculates a final loss. In some examples, the example loss calculator circuitry 428 determines a final loss function based on the losses determined by the example pixel-wise calculator circuitry 422, the example classification loss calculator circuitry 424, and the example triplet loss calculation circuitry 426. The example loss calculator circuitry 428 determines the final loss function using example Equation 3 described above in relation to FIG. 4. In some examples, the loss calculator circuitry 428 uses the final loss function to determine scores for classifications between the features from the example input image and the class of the PIANet circuitry 304. After block 1220, process 1106 completes and returns to process 1100 of FIG. 11.

FIG. 13 is a flowchart representative of example machine readable instructions and/or example operations 1204 that may be executed and/or instantiated by processor circuitry to implement the example first neural network layer 404, the example second neural network layer 406, an example third neural network layer 408, the example fourth neural network layer 410, and the example self-attention module circuitry 412A, 412B, 412C included in the example PIANet circuitry 304 of FIGS. 4 and/or 5. In the illustrated example of FIG. 13, the example operations 1204 are illustrated in series. However, the example operations can be executed in parallel. The machine readable instructions and/or operations 1204 of FIG. 13 begin at block 1302, at which the example first neural network layer 404 extracts features in a first layer. The example first neural network layer 404 receives the example input image data 402. The example first neural network layer 404 extracts features from the example input image data 402. The example first neural network layer 404 transmits the input image data 402 and the extracted features to the second neural network layer 406 for deeper level feature extraction. The example first neural network layer 404 also transmits the input image data 402 and the extracted features to the self-attention module circuitry 412A to allow for feature focus on a torso region of a player included in the example input image data 402.

At block 1304, the example second neural network layer 406 extracts features in a second layer. The example second neural network layer 406 further extracts features from the example input image data 402. The example second neural network layer 406 transmits the input image data 402 and the extracted features to the third neural network layer 408 for deeper level feature extraction. The example second neural network layer 406 also transmits the input image data 402 and the extracted features to the self-attention module circuitry 412A to allow for feature focus on a torso region of a player included in the example input image data 402.

At block 1306, the example self-attention module circuitry 412A runs a first self-attention module with the first layer features and the second layer features. In some examples, the example self-attention module circuitry 412A iteratively identifies the player torso region in the example input image and focuses the extracted features from the example first neural network layer 404 and the example second neural network layer 406 in the identified region. The example self-attention module circuitry 412A concatenates raw features from the example first neural network layer 404 and the example second neural network layer 406 and the features after running the self-attention module circuitry 412A in the channel dimension. The example self-attention module circuitry 412A determines the features in the identified player torso region both in the channel and spatial dimensions. An example flow diagram of the example self-attention module circuitry 412A is described above in connection with FIG. 5.

At block 1308, the example third neural network layer 408 extracts features in a third layer. The example third neural network layer 408 further extracts features from the example input image data 402. The example third neural network layer 408 transmits the input image data 402 and the extracted features to the fourth neural network layer 410 for deeper level feature extraction. The example third neural network layer 408 also transmits the input image data 402 and the extracted features to the self-attention module circuitry 412B to allow for further feature focus on a torso region of a player included in the example input image data 402.

At block 1312, the example self-attention module circuitry 412B runs a second self-attention module with the third layer features and the first self-attention module results. In some examples, the example self-attention module circuitry 412B iteratively identifies the player torso region in the example input image and focuses the extracted features from the example third neural network layer 408 and the results from the example self-attention module circuitry 412A in the identified region. The example self-attention module circuitry 412B concatenates raw features from third neural network layer 408 and the results from the example self-attention module circuitry 412A and the features after running the self-attention module circuitry 412B in the channel dimension. The example self-attention module circuitry 412B determines the features in the identified player torso region both in the channel and spatial dimensions. An example flow diagram of the example self-attention module circuitry 412B is described above in connection with FIG. 5.

At block 1312, the example fourth neural network layer 410 extracts features in a fourth layer. The example fourth neural network layer 410 further extracts features from the example input image data 402. The example fourth neural network layer 410 transmits the input image data 402 and the extracted features to the self-attention module circuitry 412C to allow for further feature focus on a torso region of a player included in the example input image data 402.

At block 1314, the example self-attention module circuitry 412C runs a third self-attention module with the fourth layer features and the second self-attention module results. In some examples, the example self-attention module circuitry 412C iteratively identifies the player torso region in the example input image and focuses the extracted features from the example fourth neural network layer 410 and the results from the example self-attention module circuitry 412B in the identified region. The example self-attention module circuitry 412C concatenates raw features from fourth neural network layer 410 and the results from the example self-attention module circuitry 412B and the features after running the self-attention module circuitry 412C in the channel dimension. The example self-attention module circuitry 412C determines the features in the identified player torso region both in the channel and spatial dimensions. An example flow diagram of the example self-attention module circuitry 412C is described above in connection with FIG. 5. After block 1314, process 1204 completes and returns to process 1106 of FIG. 12.

FIG. 14 is a flowchart representative of example machine readable instructions and/or example operations 1112 that may be executed and/or instantiated by processor circuitry to implement the example class score calculation circuitry 310 and the example pairwise correlation calculation circuitry 312 included in the example multi-camera team feature fusion circuitry 308 of FIG. 3. The machine readable instructions and/or operations 1112 of FIG. 14 begin at block 1402, at which the example class score calculation circuitry 310 obtains player bounding boxes. In some examples, the class score calculation circuitry 310 obtains the player bounding boxes from the example player association circuitry 306. At block 1404, the example class score calculation circuitry 310 obtains the scores from the attention module circuitry. The example class score calculation circuitry 310 determines the example classes from the output of the example PIANet circuitry 304. In examples disclosed herein, the example classes are team classifications based on jersey appearances for the teams. The example class score calculation circuitry 310 determines the scores for each of the example classes based on the loss function outputs of the PIANet circuitry 304 for the example image data.

At block 1406, the example pairwise correlation calculation circuitry 312 calculates correlation coefficients for each class pair. The example pairwise correlation calculation circuitry 312 calculates correlation coefficients for pairs of classes to select the two classes with the smallest correlation scores from the output of the PIANet circuitry 304. The example pairwise correlation calculation circuitry 312 uses the associated player bounding box information from the example player association circuitry 306 and the class scores determined by the example class score calculation circuitry 310 based on the output of the example PIANet circuitry 304. The example pairwise correlation calculation circuitry 312 calculates a correlation coefficient between each class pair using example Equation 1 described above in connection with FIG. 3.

At block 1408, the example pairwise correlation calculation circuitry 312 selects two classes with the lowest correlation coefficient. In examples disclosed herein, similar classes will have a higher correlation coefficient since the classes likely share a similar data distribution. The example pairwise correlation calculation circuitry 312 generates a matrix to record the pairwise correlation between all class pairs. In some examples, if the data distributions of two classes are similar, the example pairwise correlation calculation circuitry 312 excludes the two class from the candidate classes set. The example pairwise correlation calculation circuitry 312 compares the correlation coefficients between the pairs of classes and selects the two classes with the smallest correlation coefficient (e.g., lowest correlated classes) for classifying the players in the game. After block 1408, process 1112 completes and returns to process 1100 of FIG. 11.

FIG. 15 is a flowchart representative of example machine readable instructions and/or example operations 1114 that may be executed and/or instantiated by processor circuitry to implement the example multi-camera voting score calculation circuitry 314 included in the example multi-camera team feature fusion circuitry 308 of FIG. 3. The machine readable instructions and/or operations 1114 of FIG. 15 begin at block 1502, at which the example multi-camera voting score calculation circuitry 314 collects all player bounding boxes for the example camera(s) 104. In some examples, due to the different angles of the camera views (e.g., the example views 106 of FIG. 1) of the example camera(s) 104 around the environment (e.g., the example environment 100), some player bounding boxes may appear very small and/or players may only be visible from one view (e.g., a side view) and not another (e.g., a front view). In such examples, a small sized bounding box will have weaker features than a larger sized bounding box, and team features between two players from a side view will be much less discriminative than from a front view. The example multi-camera voting score calculation circuitry 314 combines the team classification results from the different views of the example camera(s) 104 to output a team label for a player that is more accurate than relying on only one view from one of the example camera(s) 104. The example multi-camera voting score calculation circuitry 314 collects all player bounding boxes determined by the example player association circuitry 306. At block 1504, the example multi-camera voting score calculation circuitry 314 associates players across all camera views.

At block 1506, the example multi-camera voting score calculation circuitry 314 divide the associated bounding boxes into groups. For each bounding box associated with each player, the example multi-camera voting score calculation circuitry 314 divides the bounding boxes into two groups associated with the two selected classes from the example pairwise correlation calculation circuitry 312. At block 1508, the example multi-camera voting score calculation circuitry 314 calculates the voting score for each group. For each group of bounding boxes, the example multi-camera voting score calculation circuitry 314 calculates a voting score using example Equation 2 described above in connection with FIG. 3. In the example Equation 2 above, the voting score is influenced by the confidence output because the larger the confidence, the more reliable the label is. The example Equation 2 above includes the area of the current bounding box because the larger the area of the bounding box, the more reliable and useful the features are from the bounding box. In the example Equation 2, the voting score is based on the width and height of the current bounding box for the cases when the image data from a camera looks at a player from a side view, which causes the bounding box to be relatively narrow compared to a frontal view. In the example Equation 2, the width and height of the bounding box represent the degree of player body deflection relative to the camera. The example multi-camera voting score calculation circuitry 314 determines the voting scores for both groups of bounding boxes using example Equation 2 and determines which group has the higher voting score.

At block 1510, the example multi-camera voting score calculation circuitry 314 labels players with a team label of highest score. The example multi-camera voting score calculation circuitry 314 determines the team classification label for player identified in the bounding boxes based on the group with the higher voting score. The example multi-camera voting score calculation circuitry 314 determines the final team labels for all players in the bounding boxes based on the voting score results and outputs the final team labels to the example results generator circuitry 212 of FIG. 2. After block 1510, process 1114 completes and returns to process 1100 of FIG. 11.

FIG. 16 is a block diagram of an example processor platform 1600 structured to execute and/or instantiate the machine readable instructions and/or operations of FIGS. 11-15 to implement the example team classification circuitry 210 of FIGS. 2 and/or 3. The processor platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1600 of the illustrated example includes processor circuitry 1612. The processor circuitry 1612 of the illustrated example is hardware. For example, the processor circuitry 1612 can be implemented by one or more integrated circuits, logic circuits, FPGAs microprocessors, CPUs, GPUs, DSPs, and/or microcontrollers from any desired family or manufacturer. The processor circuitry 1612 may be implemented by one or more semiconductor based (e.g., silicon based) devices. In this example, the processor circuitry 1612 implements the example player detection circuitry 302, the example pose-guided iterative attention network circuitry 304, the example player association circuitry 306, the example multi-camera team feature fusion circuitry 308, the example class score calculation circuitry 310, the example pairwise correlation calculation circuitry 312, and the example multi-camera voting score calculation circuitry 314.

The processor circuitry 1612 of the illustrated example includes a local memory 1613 (e.g., a cache, registers, etc.). The processor circuitry 1612 of the illustrated example is in communication with a main memory including a volatile memory 1614 and a non-volatile memory 1616 by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617.

The processor platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1622 are connected to the interface circuitry 1620. The input device(s) 1622 permit(s) a user to enter data and/or commands into the processor circuitry 1612. The input device(s) 1622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1624 are also connected to the interface circuitry 1620 of the illustrated example. The output devices 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1600 of the illustrated example also includes one or more mass storage devices 1628 to store software and/or data. Examples of such mass storage devices 1628 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1632, which may be implemented by the machine readable instructions of FIGS. 11-15, may be stored in the mass storage device 1628, in the volatile memory 1614, in the non-volatile memory 1616, and/or on a removable non-transitory computer readable storage medium such as a CD or DVD.

FIG. 17 is a block diagram of an example implementation of the processor circuitry 1612 of FIG. 16. In this example, the processor circuitry 1612 of FIG. 16 is implemented by a microprocessor 1700. For example, the microprocessor 1700 may implement multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowcharts of FIGS. 11-15.

The cores 1702 may communicate by an example bus 1704. In some examples, the bus 1704 may implement a communication bus to effectuate communication associated with one(s) of the cores 1702. For example, the bus 1704 may implement at least one of an Inter-Integrated Circuit (I2C) bus, a Serial Peripheral Interface (SPI) bus, a PCI bus, or a PCIe bus. Additionally or alternatively, the bus 1704 may implement any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2_cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the L1 cache 1720, and an example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating point operations. In yet other examples, the AL circuitry 1716 may include first AL circuitry that performs integer based operations and second AL circuitry that performs floating point operations. In some examples, the AL circuitry 1716 may be referred to as an Arithmetic Logic Unit (ALU). The registers 1718 are semiconductor-based structures to store data and/or instructions such as results of one or more of the operations performed by the AL circuitry 1716 of the corresponding core 1702. For example, the registers 1718 may include vector register(s), SIMD register(s), general purpose register(s), flag register(s), segment register(s), machine specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure including distributed throughout the core 1702 to shorten access time. The bus 1720 may implement at least one of an I2C bus, a SPI bus, a PCI bus, or a PCIe bus

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general puspose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 18 is a block diagram of another example implementation of the processor circuitry 1612 of FIG. 16. In this example, the processor circuitry 1612 is implemented by FPGA circuitry 1700. The FPGA circuitry 1700 can be used, for example, to perform operations that could otherwise be performed by the example microprocessor 1700 of FIG. 17 executing corresponding machine readable instructions. However, once configured, the FPGA circuitry 1700 instantiates the machine readable instructions in hardware and, thus, can often execute the operations faster than they could be performed by a general purpose microprocessor executing the corresponding software.

More specifically, in contrast to the microprocessor 1700 of FIG. 17 described above (which is a general purpose device that may be programmed to execute some or all of the machine readable instructions represented by the flowcharts of FIGS. 11-15 but whose interconnections and logic circuitry are fixed once fabricated), the FPGA circuitry 1700 of the example of FIG. 18 includes interconnections and logic circuitry that may be configured and/or interconnected in different ways after fabrication to instantiate, for example, some or all of the machine readable instructions represented by the flowcharts of FIGS. 11-15. In particular, the FPGA 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the software represented by the flowcharts of FIGS. 11-15. As such, the FPGA circuitry 1700 may be structured to effectively instantiate some or all of the machine readable instructions of the flowcharts of FIGS. 11-15 as dedicated logic circuits to perform the operations corresponding to those software instructions in a dedicated manner analogous to an ASIC. Therefore, the FPGA circuitry 1700 may perform the operations corresponding to the some or all of the machine readable instructions of FIGS. 11-15 faster than the general purpose microprocessor can execute the same.

In the example of FIG. 18, the FPGA circuitry 1800 is structured to be programmed (and/or reprogrammed one or more times) by an end user by a hardware description language (HDL) such as Verilog. The FPGA circuitry 1800 of FIG. 18, includes example input/output (I/O) circuitry 1802 to obtain and/or output data to/from example configuration circuitry 1804 and/or external hardware (e.g., external hardware circuitry) 1806. For example, the configuration circuitry 1804 may implement interface circuitry that may obtain machine readable instructions to configure the FPGA circuitry 1800, or portion(s) thereof. In some such examples, the configuration circuitry 1804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1806 may implement the microprocessor 1700 of FIG. 17. The FPGA circuitry 1800 also includes an array of example logic gate circuitry 1808, a plurality of example configurable interconnections 1810, and example storage circuitry 1812. The logic gate circuitry 1808 and interconnections 1810 are configurable to instantiate one or more operations that may correspond to at least some of the machine readable instructions of FIGS. 11-15 and/or other desired operations. The logic gate circuitryl808 shown in FIG. 18 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations. The logic gate circuitry 1808 may include other electrical structures such as look-up tables (LUTs), registers (e.g., flip-flops or latches), multiplexers, etc.

The interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example Dedicated Operations Circuitry 1814. In this example, the Dedicated Operations Circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the processor circuitry 1612 of FIG. 16, many other approaches are contemplated. For example, as mentioned above, modern FPGA circuitry may include an on-board CPU, such as one or more of the example CPU 1820 of FIG. 18. Therefore, the processor circuitry 1612 of FIG. 16 may additionally be implemented by combining the example microprocessor 1700 of FIG. 17 and the example FPGA circuitry 1800 of FIG. 18. In some such hybrid examples, a first portion of the machine readable instructions represented by the flowcharts of FIGS. 11-15 may be executed by one or more of the cores 1702 of FIG. 17 and a second portion of the machine readable instructions represented by the flowcharts of FIGS. 11-15 may be executed by the FPGA circuitry 1800 of FIG. 18.

In some examples, the processor circuitry 1612 of FIG. 16 may be in one or more packages. For example, the processor circuitry 1700 of FIG. 17 and/or the FPGA circuitry 1700 of FIG. 17 may be in one or more packages. In some examples, an XPU may be implemented by the processor circuitry 1612 of FIG. 16, which may be in one or more packages. For example, the XPU may include a CPU in one package, a DSP in another package, a GPU in yet another package, and an FPGA in still yet another package.

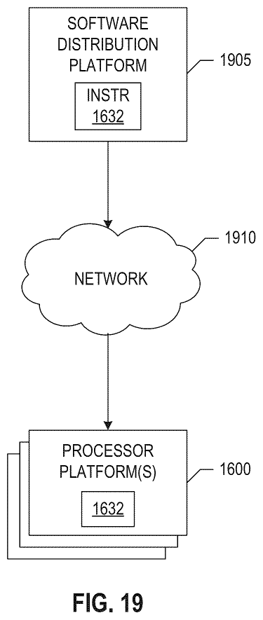

A block diagram illustrating an example software distribution platform 1905 to distribute software such as the example machine readable instructions 1632 of FIG. 16 to hardware devices owned and/or operated by third parties is illustrated in FIG. 19. The example software distribution platform 1905 may be implemented by any computer server, data facility, cloud service, etc., capable of storing and transmitting software to other computing devices. The third parties may be customers of the entity owning and/or operating the software distribution platform 1905. For example, the entity that owns and/or operates the software distribution platform 1905 may be a developer, a seller, and/or a licensor of software such as the example machine readable instructions 1632 of FIG. 16. The third parties may be consumers, users, retailers, OEMs, etc., who purchase and/or license the software for use and/or re-sale and/or sub-licensing. In the illustrated example, the software distribution platform 1905 includes one or more servers and one or more storage devices. The storage devices store the machine readable instructions 1632, which may correspond to the example machine readable instructions 1100, 1106, 1204, 1112, and 1114 of FIGS. 11-15, as described above. The one or more servers of the example software distribution platform 1905 are in communication with a network 1910, which may correspond to any one or more of the Internet and/or any of the example network 1626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 1905. For example, the software, which may correspond to the example machine readable instructions 1100, 1106, 1204, 1112, and 1114 of FIGS. 11-15, may be downloaded to the example processor platform 1600, which is to execute the machine readable instructions 1632 to implement the example team classification circuitry 210. In some example, one or more servers of the software distribution platform 1905 periodically offer, transmit, and/or force updates to the software (e.g., the example machine readable instructions 1632 of FIG. 16) to ensure improvements, patches, updates, etc., are distributed and applied to the software at the end user devices.

From the foregoing, it will be appreciated that example systems, methods, apparatus, and articles of manufacture have been disclosed that automatically and accurately classify players in a sports game into separate teams based on image data. The disclosed systems, methods, apparatus, and articles of manufacture do not require manual operation or live game data to train the models for team classification. The disclosed systems, methods, apparatus, and articles of manufacture include a multi-head iterative attention network structure that leverages the upper body heatmap to highlight relevant regions both at channel and spatial dimensions and iteratively extracts features from the low-level details of the image data to the high-level semantics. The disclosed systems, methods, apparatus, and articles of manufacture improve the efficiency of using a computing device by including the multi-head iterative attention network structure that achieves feature discriminability using a fewer number of classes while maintaining reliability and improving the stability and generalization ability of the team classification. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for team classification in sports analysis are disclosed herein. Further examples and combinations thereof include the following: Example 1 includes an apparatus comprising at least one memory, instructions in the apparatus, and processor circuitry to execute the instructions to extract features from image data obtained from a plurality of cameras, the extraction of features performed using a plurality of sequential neural network layers, in response to each of the plurality of sequential neural network layer extracting the features, identify the extracted features in a torso region of the image data via a plurality of attention modules in parallel with each of the plurality of sequential neural network layers, estimate body landmarks from image data to localize an area, generate an upper heatmap mask based on a geometric center of the image data, calculate a loss function for the image data based on a cross-entropy loss, a pixel-wise loss, and a triplet loss determined from the extracted features and the generated heatmap mask, select lowest correlated classes based on calculated correlations between pairs of a plurality of classes, and calculate voting scores for groups associated with the lowest correlated classes based on the image data and the loss function.

Example 2 includes the apparatus of example 1, wherein the plurality of sequential neural network layers includes at least four sequential neural network layers, and the plurality of attention modules includes at least three attention modules.

Example 3 includes the apparatus of example 1, wherein to determine the extracted features in a channel dimension, the processor circuitry is to perform global maximum pooling on the extracted features, compress the extracted features via convolution, perform a leaky rectified linear unit function, recover feature channels to match number of the image data, and normalize the extracted features with sigmoid function.

Example 4 includes the apparatus of example 3, wherein to determine the extracted features in a spatial dimension, the processor circuitry is to scale the extracted features to a fourth size of image data, transpose the extracted features, determine a self-correlation factor by multiplying the scaled extracted features by the transposed extracted features, multiply the self-correlation factor by convolution of the extracted features, and perform convolution to match channel number of the extracted features and channel number of image data.

Example 5 includes the apparatus of example 4, wherein the processor circuitry is to identify the extracted features in the torso region by combining the extracted features in the channel dimension and the extracted features in the spatial dimension.

Example 6 includes the apparatus of example 1, wherein the processor circuitry is to estimate the body landmarks and generate the upper heatmap mask in parallel to the plurality of sequential neural network layers.

Example 7 includes the apparatus of example 1, wherein the area is an upper torso area.

Example 8 includes the apparatus of example 1, wherein the processor circuitry is to calculate correlation coefficients for pairs of classes, wherein each class is a team classification.

Example 9 includes the apparatus of example 1, wherein the processor circuitry is to associate a label with the image data based on the voting score.

Example 10 includes the apparatus of example 9, wherein the label is to identify a presence of a uniformed personnel.

Example 11 includes the apparatus of example 1, wherein the processor circuitry is to group a player in a ground plane and determine player correspondence from the plurality of cameras, the instructions to associate bounding boxes of a player from the image data of the plurality of cameras.

Example 12 includes the apparatus of example 11, wherein the processor circuitry is to calculate the voting scores based on an area of a current bounding box, an area of a largest bounding box in the image data, width of the current bounding box, and height of the current bounding box.

Example 13 includes the apparatus of example 12, wherein the processor circuitry is to associate a team label with the image data for the player in the current bounding box.

Example 14 includes a non-transitory computer readable storage medium comprising instructions that, when executed, cause at least one processor to extract features from image data obtained from a plurality of cameras, the extraction of features performed using a plurality of sequential neural network layers, in response to each of the plurality of sequential neural network layer extracting the features, identify the extracted features in a torso region of the image data via a plurality of attention modules in parallel with each of the plurality of sequential neural network layers, estimate body landmarks from image data to localize an area, generate an upper heatmap mask based on a geometric center of the image data, calculate a loss function for the image data based on a cross-entropy loss, a pixel-wise loss, and a triplet loss determined from the extracted features and the generated heatmap mask, select lowest correlated classes based on calculated correlations between pairs of a plurality of classes, and calculate voting scores for groups associated with the lowest correlated classes based on the image data and the loss function.

Example 15 includes the non-transitory computer readable storage medium of example 14, wherein the plurality of sequential neural network layers includes at least four sequential neural network layers, and the plurality of attention modules includes at least three attention modules.

Example 16 includes the non-transitory computer readable storage medium of example 14, wherein to determine the extracted features in a channel dimension, the instructions, when executed, cause the at least one processor to perform global maximum pooling on the extracted features, compress the extracted features via convolution, perform a leaky rectified linear unit function, recover feature channels to match number of the image data, and normalize the extracted features with sigmoid function.

Example 17 includes the non-transitory computer readable storage medium of example 16, wherein to determine the extracted features in a spatial dimension, the instructions, when executed, cause the at least one processor to scale the extracted features to a fourth size of image data, transpose the extracted features, determine a self-correlation factor by multiplying the scaled extracted features by the transposed extracted features, multiply the self-correlation factor by convolution of the extracted features, and perform convolution to match channel number of the extracted features and channel number of image data.

Example 18 includes the non-transitory computer readable storage medium of example 17, wherein the instructions, when executed, cause the at least one processor to identify the extracted features in the torso region by combining the extracted features in the channel dimension and the extracted features in the spatial dimension.

Example 19 includes the non-transitory computer readable storage medium of example 14, wherein the instructions, when executed, cause the at least one processor to estimate the body landmarks and generate the upper heatmap mask in parallel to the plurality of sequential neural network layers.

Example 20 includes the non-transitory computer readable storage medium of example 14, wherein the area is an upper torso area.

Example 21 includes the non-transitory computer readable storage medium of example 14, wherein the instructions, when executed, cause the at least one processor to calculate correlation coefficients for pairs of classes, wherein each class is a team classification.

Example 22 includes the non-transitory computer readable storage medium of example 14, wherein the instructions, when executed, cause the at least one processor to associate a label with the image data based on the voting score.

Example 23 includes the non-transitory computer readable storage medium of example 22, wherein the label is to identify a presence of a uniformed personnel.

Example 24 includes the non-transitory computer readable storage medium of example 14, wherein the instructions, when executed, cause the at least one processor to group a player in a ground plane and determine player correspondence from the plurality of cameras, the instructions to associate bounding boxes of a player from the image data of the plurality of cameras.

Example 25 includes the non-transitory computer readable storage medium of example 24, wherein the instructions, when executed, cause the at least one processor to calculate the voting scores based on an area of a current bounding box, an area of a largest bounding box in the image data, width of the current bounding box, and height of the current bounding box.

Example 26 includes the non-transitory computer readable storage medium of example 25, wherein the instructions, when executed, cause the at least one processor to associate a team label with the image data for the player in the current bounding box.

Example 27 includes a method comprising extracting features from image data obtained from a plurality of cameras, the extraction of features performed using a plurality of sequential neural network layers, in response to each of the plurality of sequential neural network layer extracting the features, identifying the extracted features in a torso region of the image data via a plurality of attention modules in parallel with each of the plurality of sequential neural network layers, estimating body landmarks from image data to localize an area, generating an upper heatmap mask based on a geometric center of the image data, calculating a loss function for the image data based on a cross-entropy loss, a pixel-wise loss, and a triplet loss determined from the extracted features and the generated heatmap mask, selecting lowest correlated classes based on calculated correlations between pairs of a plurality of classes, and calculating voting scores for groups associated with the lowest correlated classes based on the image data and the loss function.

Example 28 includes the method of example 27, wherein the plurality of sequential neural network layers includes at least four sequential neural network layers, and the plurality of attention modules includes at least three attention modules.

Example 29 includes the method of example 27, wherein determining the extracted features in a channel dimension further includes performing global maximum pooling on the extracted features, compressing the extracted features via convolution, performing a leaky rectified linear unit function, recovering feature channels to match number of the image data, and normalizing the extracted features with sigmoid function.

Example 30 includes the method of example 29, wherein the determining the extracted features in a spatial dimension further includes scaling the extracted features to a fourth size of image data, transposing the extracted features, determining a self-correlation factor by multiplying the scaled extracted features by the transposed extracted features, multiplying the self-correlation factor by convolution of the extracted features, and performing convolution to match channel number of the extracted features and channel number of image data.

Example 31 includes the method of example 30, further including identifying the extracted features in the torso region by combining the extracted features in the channel dimension and the extracted features in the spatial dimension.

Example 32 includes the method of example 27, further including estimating the body landmarks and generate the upper heatmap mask in parallel to the plurality of sequential neural network layers.

Example 33 includes the method of example 27, wherein the area is an upper torso area.

Example 34 includes the method of example 27, further including calculating correlation coefficients for pairs of classes, wherein each class is a team classification.

Example 35 includes the method of example 27, further including associating a label with the image data based on the voting score.

Example 36 includes the method of example 35, wherein the label is to identify a presence of a uniformed personnel.

Example 37 includes the method of example 27, further including grouping a player in a ground plane and determine player correspondence from the plurality of cameras, and associating bounding boxes of a player from the image data of the plurality of cameras.

Example 38 includes the method of example 37, further including calculating the voting scores based on an area of a current bounding box, an area of a largest bounding box in the image data, width of the current bounding box, and height of the current bounding box.

Example 39 includes the method of example 38, further including associating a team label with the image data for the player in the current bounding box.

Example 40 includes an apparatus comprising pose-guided iterative attention network circuitry to extract features from image data obtained from a plurality of cameras, the extraction of features performed using a plurality of sequential neural network layers, in response to each of the plurality of sequential neural network layer extracting the features, identify the extracted features in a torso region of the image data via a plurality of attention modules in parallel with each of the plurality of sequential neural network layers, estimate body landmarks from image data to localize an area, generate an upper heatmap mask based on a geometric center of the image data, and calculate a loss function for the image data based on a cross-entropy loss, a pixel-wise loss, and a triplet loss determined from the extracted features and the generated heatmap mask, pairwise correlation calculation circuitry to select lowest correlated classes based on calculated correlations between pairs of a plurality of classes, and multi-camera voting score calculation circuitry to calculate voting scores for groups associated with the lowest correlated classes based on the image data and the loss function.

Example 41 includes the apparatus of example 40, wherein the plurality of sequential neural network layers includes at least four sequential neural network layers, and the plurality of attention modules includes at least three attention modules.

Example 42 includes the apparatus of example 40, wherein to determine the extracted features in a channel dimension, the pose-guided iterative attention network circuitry is to perform global maximum pooling on the extracted features, compress the extracted features via convolution, perform a leaky rectified linear unit function, recover feature channels to match number of the image data, and normalize the extracted features with sigmoid function.

Example 43 includes the apparatus of example 42, wherein to determine the extracted features in a spatial dimension, the pose-guided iterative attention network circuitry is to scale the extracted features to a fourth size of image data, transpose the extracted features, determine a self-correlation factor by multiplying the scaled extracted features by the transposed extracted features, multiply the self-correlation factor by convolution of the extracted features, and perform convolution to match channel number of the extracted features and channel number of image data.

Example 44 includes the apparatus of example 43, wherein the pose-guided iterative attention network circuitry is to identify the extracted features in the torso region by combining the extracted features in the channel dimension and the extracted features in the spatial dimension.

Example 45 includes the apparatus of example 40, wherein the pose-guided iterative attention network circuitry is to estimate the body landmarks and generate the upper heatmap mask in parallel to the plurality of sequential neural network layers.

Example 46 includes the apparatus of example 40, wherein the area is an upper torso area.

Example 47 includes the apparatus of example 40, wherein pairwise correlation calculation circuitry is to calculate correlation coefficients for pairs of classes, wherein each class is a team classification.

Example 48 includes the apparatus of example 40, wherein the multi-camera voting score calculation circuitry is to associate a label with the image data based on the voting score.

Example 49 includes the apparatus of example 48, wherein the label is to identify a presence of a uniformed personnel.

Example 50 includes the apparatus of example 40, further including player association circuitry to group a player in a ground plane and determine player correspondence from the plurality of cameras, the player association circuitry to associate bounding boxes of a player from the image data of the plurality of cameras.

Example 51 includes the apparatus of example 50, wherein the multi-camera voting score calculation circuitry is to calculate the voting scores based on an area of a current bounding box, an area of a largest bounding box in the image data, width of the current bounding box, and height of the current bounding box.

Example 52 includes the apparatus of example 51, wherein the multi-camera voting score calculation circuitry is to associate a team label with the image data for the player in the current bounding box.

Example 53 includes an apparatus comprising means for extracting features, the means for extracting to extract features from image data obtained from a plurality of cameras, the extraction of features performed using a plurality of sequential neural network layers, in response to each of the plurality of sequential neural network layer extracting the features, identify the extracted features in a torso region of the image data via a plurality of attention modules in parallel with each of the plurality of sequential neural network layers, estimate body landmarks from image data to localize an area, generate an upper heatmap mask based on a geometric center of the image data, and calculate a loss function for the image data based on a cross-entropy loss, a pixel-wise loss, and a triplet loss determined from the extracted features and the generated heatmap mask, means for selecting lowest correlated classes based on calculated correlations between pairs of a plurality of classes, and means for calculating voting scores for groups associated with the lowest correlated classes based on the image data and the loss function.

Example 54 includes the apparatus of example 53, wherein the plurality of sequential neural network layers includes at least four sequential neural network layers, and the plurality of attention modules includes at least three attention modules.

Example 55 includes the apparatus of example 53, wherein to determine the extracted features in a channel dimension, the means for extracting is to perform global maximum pooling on the extracted features, compress the extracted features via convolution, perform a leaky rectified linear unit function, recover feature channels to match number of the image data, and normalize the extracted features with sigmoid function.

Example 56 includes the apparatus of example 55, wherein to determine the extracted features in a spatial dimension, the means for extracting is to scale the extracted features to a fourth size of image data, transpose the extracted features, determine a self-correlation factor by multiplying the scaled extracted features by the transposed extracted features, multiply the self-correlation factor by convolution of the extracted features, and perform convolution to match channel number of the extracted features and channel number of image data.

Example 57 includes the apparatus of example 56, wherein the means for extracting is to identify the extracted features in the torso region by combining the extracted features in the channel dimension and the extracted features in the spatial dimension.

Example 58 includes the apparatus of example 53, wherein the means for extracting is to estimate the body landmarks and generate the upper heatmap mask in parallel to the plurality of sequential neural network layers.

Example 59 includes the apparatus of example 53, wherein the area is an upper torso area.

Example 60 includes the apparatus of example 53, wherein the means for selecting is to calculate correlation coefficients for pairs of classes, wherein each class is a team classification.

Example 61 includes the apparatus of example 53, wherein the means for calculating is to associate a label with the image data based on the voting score.

Example 62 includes the apparatus of example 61, wherein the label is to identify a presence of a uniformed personnel.

Example 63 includes the apparatus of example 53, further including means for grouping a player in a ground plane and determine player correspondence from the plurality of cameras, the means for grouping to associate bounding boxes of a player from the image data of the plurality of cameras.

Example 64 includes the apparatus of example 63, wherein the means for calculating is to calculate the voting scores based on an area of a current bounding box, an area of a largest bounding box in the image data, width of the current bounding box, and height of the current bounding box.

Example 65 includes the apparatus of example 64, wherein the means for calculating is to associate a team label with the image data for the player in the current bounding box.

Example 66 includes an apparatus comprising at least one memory, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry including logic gate circuitry to perform one or more third operations, the processor circuitry to at least one of perform at least one of the first operations, the second operations or the third operations to extract features from image data obtained from a plurality of cameras, the extraction of features performed using a plurality of sequential neural network layers, in response to each of the plurality of sequential neural network layer extracting the features, identify the extracted features in a torso region of the image data via a plurality of attention modules in parallel with each of the plurality of sequential neural network layers, estimate body landmarks from image data to localize an area, generate an upper heatmap mask based on a geometric center of the image data, calculate a loss function for the image data based on a cross-entropy loss, a pixel-wise loss, and a triplet loss determined from the extracted features and the generated heatmap mask, select lowest correlated classes based on calculated correlations between pairs of a plurality of classes, and calculate voting scores for groups associated with the lowest correlated classes based on the image data and the loss function.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory;
instructions in the apparatus; and
processor circuitry to execute the instructions to:
extract features from image data obtained from a plurality of cameras, the extraction of features performed using a plurality of sequential neural network layers;
in response to each of the plurality of sequential neural network layer extracting the features, identify the extracted features in a torso region of the image data via a plurality of attention modules in parallel with each of the plurality of sequential neural network layers;
estimate body landmarks from image data to localize an area;
generate an upper heatmap mask based on a geometric center of the image data;
calculate a loss function for the image data based on a cross-entropy loss, a pixel-wise loss, and a triplet loss determined from the extracted features and the generated heatmap mask;
select lowest correlated classes based on calculated correlations between pairs of a plurality of classes; and
calculate voting scores for groups associated with the lowest correlated classes based on the image data and the loss function.

2. The apparatus of claim 1, wherein the plurality of sequential neural network layers includes at least four sequential neural network layers, and the plurality of attention modules includes at least three attention modules.

3. The apparatus of claim 1, wherein to determine the extracted features in a channel dimension, the processor circuitry is to:
perform global maximum pooling on the extracted features;
compress the extracted features via convolution;
perform a leaky rectified linear unit function;
recover feature channels to match number of the image data; and
normalize the extracted features with sigmoid function.

4. The apparatus of claim 3, wherein to determine the extracted features in a spatial dimension, the processor circuitry is to:
scale the extracted features to a fourth size of image data;
transpose the extracted features;
determine a self-correlation factor by multiplying the scaled extracted features by the transposed extracted features;
multiply the self-correlation factor by convolution of the extracted features; and
perform convolution to match channel number of the extracted features and channel number of image data.

5. The apparatus of claim 4, wherein the processor circuitry is to identify the extracted features in the torso region by combining the extracted features in the channel dimension and the extracted features in the spatial dimension.

6. The apparatus of claim 1, wherein the processor circuitry is to estimate the body landmarks and generate the upper heatmap mask in parallel to the plurality of sequential neural network layers.

7. The apparatus of claim 1, wherein the area is an upper torso area.

8. The apparatus of claim 1, wherein the processor circuitry is to calculate correlation coefficients for pairs of classes, wherein each class is a team classification.

9. The apparatus of claim 1, wherein the processor circuitry is to associate a label with the image data based on the voting score.

10. The apparatus of claim 9, wherein the label is to identify a presence of a uniformed personnel.

11. The apparatus of claim 1, wherein the processor circuitry is to group a player in a ground plane and determine player correspondence from the plurality of cameras, the instructions to associate bounding boxes of a player from the image data of the plurality of cameras.

12. The apparatus of claim 11, wherein the processor circuitry is to calculate the voting scores based on an area of a current bounding box, an area of a largest bounding box in the image data, width of the current bounding box, and height of the current bounding box.

13. The apparatus of claim 12, wherein the processor circuitry is to associate a team label with the image data for the player in the current bounding box.

14. A non-transitory computer readable storage medium comprising instructions that, when executed, cause at least one processor to:
extract features from image data obtained from a plurality of cameras, the extraction of features performed using a plurality of sequential neural network layers;
in response to each of the plurality of sequential neural network layer extracting the features, identify the extracted features in a torso region of the image data via a plurality of attention modules in parallel with each of the plurality of sequential neural network layers;
estimate body landmarks from image data to localize an area;
generate an upper heatmap mask based on a geometric center of the image data;
calculate a loss function for the image data based on a cross-entropy loss, a pixel-wise loss, and a triplet loss determined from the extracted features and the generated heatmap mask;
select lowest correlated classes based on calculated correlations between pairs of a plurality of classes; and
calculate voting scores for groups associated with the lowest correlated classes based on the image data and the loss function.

15. The non-transitory computer readable storage medium of claim 14, wherein the plurality of sequential neural network layers includes at least four sequential neural network layers, and the plurality of attention modules includes at least three attention modules.

16. The non-transitory computer readable storage medium of claim 14, wherein to determine the extracted features in a channel dimension, the instructions, when executed, cause the at least one processor to:
perform global maximum pooling on the extracted features;
compress the extracted features via convolution;
perform a leaky rectified linear unit function;
recover feature channels to match number of the image data; and
normalize the extracted features with sigmoid function.

17. The non-transitory computer readable storage medium of claim 16, wherein to determine the extracted features in a spatial dimension, the instructions, when executed, cause the at least one processor to:
scale the extracted features to a fourth size of image data;
transpose the extracted features;
determine a self-correlation factor by multiplying the scaled extracted features by the transposed extracted features;
multiply the self-correlation factor by convolution of the extracted features; and
perform convolution to match channel number of the extracted features and channel number of image data.

18-26. (canceled)

27. A method comprising:
extracting features from image data obtained from a plurality of cameras, the extraction of features performed using a plurality of sequential neural network layers;
in response to each of the plurality of sequential neural network layer extracting the features, identifying the extracted features in a torso region of the image data via a plurality of attention modules in parallel with each of the plurality of sequential neural network layers;
estimating body landmarks from image data to localize an area;
generating an upper heatmap mask based on a geometric center of the image data;
calculating a loss function for the image data based on a cross-entropy loss, a pixel-wise loss, and a triplet loss determined from the extracted features and the generated heatmap mask;
selecting lowest correlated classes based on calculated correlations between pairs of a plurality of classes; and
calculating voting scores for groups associated with the lowest correlated classes based on the image data and the loss function.

28-33. (canceled)

34. The method of claim 27, further including calculating correlation coefficients for pairs of classes, wherein each class is a team classification.

35. The method of claim 27, further including associating a label with the image data based on the voting score.

36-66. (canceled)
